(19) United States
(12) Patent Application Publication
(10) Pub. No.: US 2026/0179110 A1
(43) Pub. Date: Jun. 25, 2026

(54) INFORMATION PROCESSING DEVICE, INFORMATION PROCESSING METHOD, AND PROGRAM

(71) Applicant: Sony Group Corporation, Tokyo (JP)

(72) Inventors: Tatsuya Kawaoka, Tokyo (JP); Ryota Sakayama, Tokyo (JP); Godai Suzuki, Kanagawa (JP); Masatoshi Funabashi, Tokyo (JP)

(73) Assignee: Sony Group Corporation, Tokyo (JP)

(21) Appl. No.: 19/124,574

(22) PCT Filed: Oct. 24, 2023
(86) PCT No.: PCT/JP2023/038248

§ 371 Date: Apr. 25, 2025

(30) Foreign Application Priority Data
Nov. 9, 2022 (JP) 2022-179684

(51) Int. Cl. G06Q 30/02; G06F 3/0482; G06Q 10/10

(52) U.S. Cl. CPC G06Q 30/02; G06F 3/0482; G06Q 10/10

(57) ABSTRACT

The present technology relates to an information processing device, an information processing method, and a program that enable the appropriate assessment of states of ecosystems.

An ecosystem assessment unit assesses the state of an ecosystem where predetermined plant species exist on the basis of interactions between plant-symbiotic microbial species that are microbial species symbiotic with the predetermined plant species and the other biological species. The present technology can be applied to, for example, an ecosystem assistance system that assists in the construction of a desired ecosystem, and the like.

### TECHNICAL FIELD

The present technology relates to an information processing device, an information processing method, and a program, and particularly relates to, for example, an information processing device, an information processing method, and a program that enable the appropriate assessment of the states of ecosystems.

### BACKGROUND ART

In recent years, Synecoculture (registered trademark) based on biodiversity exceeding a natural state through vegetation arrangement and thinning harvest from mixed dense planting under the constraints of no till, no fertilizer, and no pesticides, with only seeds and seedlings introduced has attracted attention.

For example, there has been proposed a technology to specify cultivation conditions (cultivation method) for desired medicinal plants using Synecoculture (registered trademark), specifically, cultivation conditions that enhance biodiversity and interactions to increase active ingredients of medicinal plants (see, for example, Patent Document 1).

### CITATION LIST

### Patent Document

Patent Document 1: WO 2022/019114 A

### SUMMARY OF THE INVENTION

### Problems to be Solved by the Invention

Under Synecoculture (registered trademark), an extended ecosystem with enhanced biodiversity and ecosystem function is constructed. A proposal for a technology to appropriately assess the states of various ecosystems including such extended ecosystems is being requested.

The present technology has been made in view of such circumstances, and is intended to appropriately assess the states of ecosystems.

### Solutions to Problems

An information processing device or a program of the present technology is an information processing device including an ecosystem assessment unit that assesses a state of an ecosystem where predetermined plant species exist on the basis of the interactions between plant-symbiotic microbial species that are microbial species symbiotic with the predetermined plant species and the other biological species or a program causing a computer to function as such an information processing device.

An information processing method of the present technology includes assessing a state of an ecosystem where predetermined plant species exist on the basis of the interactions between plant-symbiotic microbial species that are microbial species symbiotic with the predetermined plant species and other biological species.

According to the present technology, the state of an ecosystem where predetermined plant species exist is assessed on the basis of the interactions between plant-symbiotic microbial species that are microbial species symbiotic with the predetermined plant species and the other biological species.

The information processing device may be an independent device or an internal block constituting one device.

The program can be provided by being recorded on a recording medium or by being transmitted via a transmission medium.

### BRIEF DESCRIPTION OF DRAWINGS

FIG. 1 is a diagram illustrating a configuration example of an embodiment of an information processing system to which the present technology is applied.

FIG. 2 is a diagram illustrating a hardware configuration example of a terminal 11.

FIG. 3 is a diagram illustrating a hardware configuration example of a server 12.

FIG. 4 is a block diagram illustrating a functional configuration example of the server 12.

FIG. 5 is a flowchart illustrating an example of the outline of processing of the server 12.

FIG. 6 is a diagram illustrating an example of a plant species list generated by the terminal 11.

FIG. 7 is a diagram illustrating an example of a plant-symbiotic microbial species DB of a database 13.

FIG. 8 is a diagram illustrating an example of a network graph showing relationships between plant species and plant-symbiotic microbial species associated with each other in the plant-symbiotic microbial species DB.

FIG. 9 is a diagram illustrating an example of a microbial species list generated using plant-symbiotic microbial species and symbiotic probability.

FIG. 10 is a diagram illustrating an example of a group of plant-symbiotic microbial species in the microbial species list.

FIG. 11 is a block diagram illustrating a first configuration example of an ecosystem assessment unit 53.

FIG. 12 is a flowchart for describing an example of processing of an assessment unit 61.

FIG. 13 is a diagram illustrating an example of a microbial species functions DB of the database 13.

FIG. 14 is a diagram for describing an example of processing of a plant-symbiotic microbial species acquisition unit 52.

FIG. 15 is a diagram for describing an example of processing of the ecosystem assessment unit 53.

FIG. 16 is a diagram for describing another example of the processing of the ecosystem assessment unit 53.

FIG. 17 is a block diagram illustrating a second configuration example of the ecosystem assessment unit 53.

FIG. 18 is a flowchart illustrating an example of processing of the server 12 in a case where a vegetation strategy is proposed on the basis of the assessment result of the state of the ecosystem.

FIG. 19 is a flowchart for describing an example of processing of the server 12 in a case where an assessment method for assessing the state of the ecosystem is set on the basis of a construction purpose and the state of the ecosystem is assessed using the assessment method.

FIG. 20 is a diagram illustrating another example of the plant-symbiotic microbial species DB of the database 13.

FIG. 21 is a diagram illustrating a first example of a presentation UI.

FIG. 22 is a diagram illustrating a second example of the presentation UI.

FIG. 23 is a diagram illustrating a third example of the presentation UI.

FIG. 24 is a flowchart for describing another example of the outline of processing of the server 12.

FIG. 25 is a flowchart for describing an example of processing of the server 12 in a case where the state of the ecosystem is assessed using an assessment method aimed at reducing the risk of pandemic infections in livestock animals.

FIG. 26 is a flowchart for describing an example of processing of the server 12 in a case where a vegetation strategy aimed at reducing the risk of pandemic infections in livestock animals is proposed.

### MODE FOR CARRYING OUT THE INVENTION

### Embodiment of Information Processing System to which Present Technology is Applied

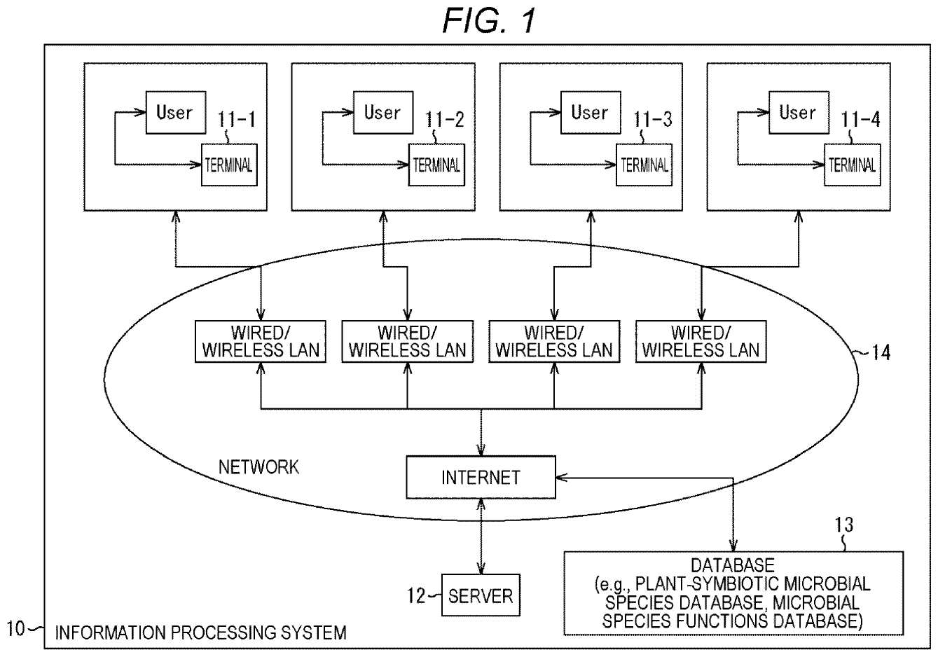

FIG. 1 is a diagram illustrating a configuration example of an embodiment of an information processing system to which the present technology is applied.

An information processing system 10 serves as, for example, an ecosystem assistance system that assists in the construction of an ecosystem aligned with the purpose of ecosystem construction (construction purpose) by assessing the state of the ecosystem using (the information regarding) microbial species existing in the ecosystem and enabling the confirmation of the state the constructed ecosystem.

Examples of the functions of the ecosystem (ecosystem functions) include a topsoil formation function, stabilization of water cycle, sustainable food production, climate stabilization, and disease suppression. It is known that humans can enjoy benefits such as safe food, clean air and water, psychological relaxation, and normalization of the immune system through the ecosystem functions.

It is known that a decline in the ecosystem functions causes a decline in gut microbiota diversity, immune system dysregulation due to a deficiency of micronutrients, a reduction in infection prevention effects due to the topsoil ecosystem, and a decline in well-being due to increased psychological stress, and humans are affected in various ways, including the onset of immune-related diseases and emerging infectious diseases.

Recent studies have revealed that the onset of immune-related diseases and emerging infectious diseases is influenced by various factors such as food quality and gut microbiota diversity. Improvements in food quality and gut microbiota diversity can be achieved by an extended ecosystem obtained by enhancing the ecosystem (function) by human activities.

Synecoculture (registered trademark) is an agricultural method that generates a site where plants are intermixed and densely planted to enhance biodiversity, and it has been revealed that Synecoculture (registered trademark) produce is richer in nutrients derived from soil microorganisms and phytochemicals than monoculture produce.

In modern life, it has been found that there is a deficiency of nutrients derived from soil microorganisms, such as B vitamins, and such a deficiency of nutrients increases the risk of immune-related diseases. The produce from a healthy topsoil ecosystem can contribute to the regulation of gut microbiota and the prevention of chronic diseases.

In many developed countries, as a result of continuous economic development that destroys ecosystems, diseases related to immune system dysregulation, such as allergies, rheumatoid arthritis, malignant tumors, and dementia are increasing.

In a country with a severe aging population, such as Japan, the burden of medical and caregiving costs associated with immune-related diseases has become a serious problem.

In order to build a sustainable society (achieve sustainable development goals (SDGs)), it is important to build a mechanism by which ecosystem restoration is achieved through human activities. The destruction of the ecosystem including the environment poses significant social and economic risks for all humanity.

The destruction of the ecosystem is characterized by long time scales and unclear accountability. Furthermore, it is difficult to estimate the effects of the approach for restoring the ecosystem. Therefore, there is a significant barrier to socially implementing ecosystem restoration.

Examples of an environmental assessment method include an alternative method for calculating the costs of replacing environmental goods with market goods, a conjoint analysis that assesses monetary value of the environment by presenting respondents with a plurality of alternative environmental conservation options and asking the respondents about their preferences, and the like.

However, the alternative method and the conjoint analysis enable the assessment of only some of the ecosystem functions.

Among the soil microbiota, there is microbiota called core microbiota that attracts other microbial species and serves as a hub of a network graph of (interspecies) interactions.

Research on interspecies interactions is in progress, and studies have been conducted to identify core microorganisms (microbiota) through network analysis of data from a large-scale database on interactions. Examples of the database with extensive records of interactions include global biotic interactions (GloBI).

(The information regarding) microbial species in the ecosystem can be comprehensively analyzed through metagenomic analysis. However, at present, metagenomic analysis is high-cost, and it is difficult to say that social implementation is sufficient.

The functions of the microbial species, for example, the functions of the microbial species based on the interactions with other biological species highly contributes to the ecosystem functions (ecosystem service) of the ecosystem where the microbial species exist.

It is therefore possible to achieve the appropriate assessment of the state of the ecosystem by assessing the state of the ecosystem such as the ecosystem functions, various impacts of the ecosystem functions (social impacts, the impacts on the biological species at each level (each type), and the like), and the environmental economic value of the ecosystem functions using (the information regarding) the microbial species of the ecosystem.

Therefore, the information processing system 10 can estimate (the information regarding) the microbial species of the ecosystem in a low-cost and quick manner by performing analysis using (the information regarding) the biological species of the ecosystem and quantitatively assess the state of the ecosystem using the microbial species.

Moreover, the information processing system 10 enables the visualization of the assessment result of the state of the ecosystem such as the ecosystem functions, various impacts of the ecosystem functions, and the environmental economic value of the ecosystem functions.

The user can confirm, for example, the state of the constructed ecosystem on the basis of the visualized assessment result, and can use the confirmation result to construct an ecosystem aligned with the construction purpose. As a result, it is possible for the information processing system 10 to assist in the construction of the ecosystem aligned with the construction purpose.

The information processing system 10 includes at least one terminal 11-i, at least one server 12, and a database 13. The terminal 11-i, the server 12, and the database 13 can communicate with each other over a network 14 including a wired local area network (LAN), a wireless LAN, the Internet, a mobile communication network such as 5G, and the like.

In FIG. 1, four terminals 11-1, 11-2, 11-3, and 11-4 are provided as the terminals 11-i. Alternatively, one to three, five, or more terminals 11-i may be provided. Hereinafter, the terminals 11-1, 11-2, 11-3, and 11-4 will be referred to as terminal 11 unless otherwise distinguished.

Furthermore, in FIG. 1, one server 12 is provided as the server 12, but a plurality of servers 12 may be provided. In a case where a plurality of servers 12 is provided, the plurality of servers 12 can be caused to perform processing described below in a distributed manner. Furthermore, for each of the plurality of servers 12, corresponding terminals 11 are assigned, and each server 12 can be caused to perform processing only for the assigned terminals 11.

Moreover, the information processing system 10 can cause the terminal 11 to perform some or all of the processing performed by the server 12. In a case where the terminal 11 is caused to perform all the processing performed by the server 12, the information processing system 10 can be configured without the server 12.

The terminal 11 includes, for example, a personal computer (PC) or the like, and is operated by the user. Alternatively, the terminal 11 can include a mobile terminal (device) such as a smartphone or a smart glass.

The user can operate the terminal 11 in an area (location) where the user lives, an area where the ecosystem is constructed, or any other area to input (information regarding) plant species to be introduced to construct the ecosystem and introduced plant species, the construction purpose for constructing the ecosystem, and various other necessary information.

The terminal 11 transmits, to the server 12 (via the network 14), a plant species list including plant species input according to a user's operation, purpose information indicating the construction purpose, and other necessary information.

For example, the user can input at least one plant species to be introduced into the area where the ecosystem is constructed by operating the terminal 11. The terminal 11 generates the plant species list including plant species input by the user.

Furthermore, for example, the user can capture an image of plant species introduced in any location by operating the terminal 11. The terminal 11 performs analysis (image recognition) on the captured image and generates a plant species list including the plant species appearing in the image.

The terminal 11 receives, for example, an image as a presentation user interface (UI) that presents the assessment result of the state of the ecosystem where the plant species in the plant species list exist, the vegetation strategy for constructing the ecosystem aligned with the construction purpose, and the like transmitted from the server 12 (via the network 14). For example, the terminal 11 presents the assessment result of the state of the ecosystem, the vegetation strategy, and the like to the user by displaying the presentation UI (alternatively, by outputting the presentation UI using voice).

The server 12 acquires (the information regarding) microbial species that can thrive in the ecosystem (microbial species that can exist in the ecosystem) where the plant species in the plant species list exist. For example, the server 12 receives the plant species list transmitted from the terminal 11 (via the network 14). The server 12 sets the ecosystem where the plant species in the plant species list exist as a target ecosystem targeted for state assessment, and acquires (estimates) (the information regarding) plant-symbiotic microbial species, which are microbial species symbiotic with the plant species in the plant species list, as microbial species that can thrive in the target ecosystem. Therefore, the server 12 can acquire the microbial species that can thrive in the target ecosystem without performing high-cost metagenomic analysis.

The server 12 assesses the state of the target ecosystem using the plant-symbiotic microbial species as the microbial species that can thrive in the target ecosystem.

Then, the server 12 generates a presentation UI that presents the assessment result of the state of the target ecosystem and transmits the presentation UI to the terminal 11 (via the network 14).

Note that the server 12 can generate a vegetation strategy on the basis of the assessment result of the state of the target ecosystem and generate a presentation UI including the vegetation strategy.

The server 12 consults the database 13 (via the network 14) as necessary, and performs processing using the information stored in the database 13.

The database 13 stores big data as various types of information regarding biological species. For example, the database 13 includes a plant-symbiotic microbial species DB (database), a microbial species functions DB, and the like.

The plant-symbiotic microbial species DB stores various plant species and plant-symbiotic microbial species symbiotic with the plant species in association with each other.

The microbial species functions DB stores various microorganisms and the functions of the microorganisms in association with each other.

The database 13 (the information stored therein) can be updated in response to user's input or the like. That is, the database 13 can be updated with information input according to user's operation of the terminal 11.

### <Hardware Configuration Example of Terminal 11 and Server 12>

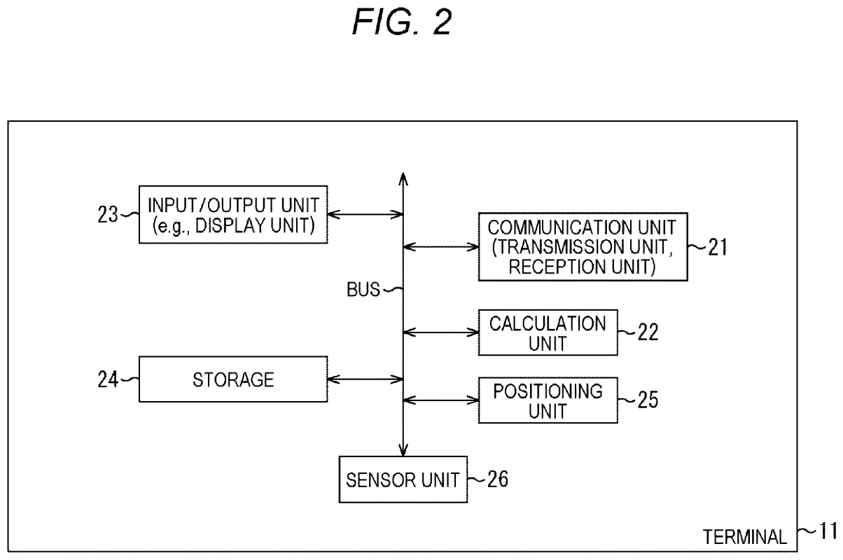

FIG. 2 is a diagram illustrating a hardware configuration example of the terminal 11.

The terminal 11 includes a communication unit 21, a calculation unit 22, an input/output unit 23, a storage 24, a positioning unit 25, and a sensor unit 26. The communication unit 21 to the sensor unit 26 are connected to each other via a bus, and can exchange information.

The communication unit 21 functions as a transmission unit that transmits information and a reception unit that receives information via the network 14.

The calculation unit 22 includes a processor such as a central processing unit (CPU) or a digital signal processor (DSP), and performs various types of processing by executing a program recorded in the storage 24.

The input/output unit 23 includes a keyboard, a touch panel, a microphone, and the like, and receives various inputs such as an operation from the user. Furthermore, the input/output unit 23 includes a speaker and a display (display unit), and presents information to the user by outputting sound, displaying an image, or the like.

The storage 24 includes a semiconductor memory such as a random access memory (RAM) or a nonvolatile memory, a solid state drive (SSD), a hard disk drive (HDD), or the like. The program executed by the calculation unit 22, data necessary for processing of the calculation unit 22, and the like are recorded (stored) in the storage 24.

The program executed by the calculation unit 22 can be installed on a computer as the terminal 11 from a removable recording medium such as a digital versatile disc (DVD) or a memory card, for example. Furthermore, for example, the program can be downloaded to the computer as the terminal 11 via the network 14 or the like and installed on the storage 24.

The positioning unit 25 constitutes, for example, a global positioning system (GPS), measures (determines) the position of the terminal 11, and outputs position information indicating the position, for example, latitude and longitude (and required altitude).

The sensor unit 26 includes, for example, various sensors such as a camera, a range sensor, a temperature sensor, and a humidity sensor, performs various types of sensing, such as capturing an image, detecting a distance, detecting a temperature, and detecting humidity, and outputs the image, the distance, the temperature, the humidity, and the like as the sensing result.

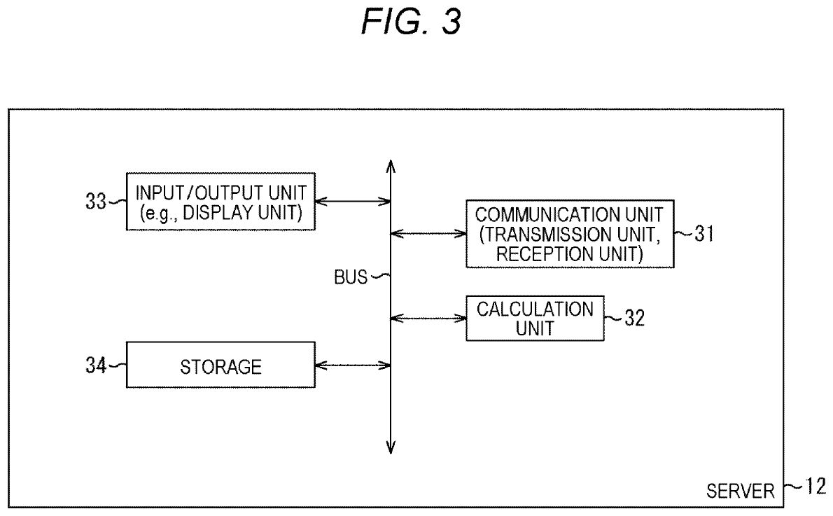

FIG. 3 is a diagram illustrating a hardware configuration example of the server 12.

The server 12 includes a communication unit 31, a calculation unit 32, an input/output unit 33, and a storage 34. The communication unit 31 to the storage 34 are configured in a similar manner to the communication unit 21 to the storage 24 in FIG. 2, respectively, and therefore, their descriptions will be omitted. Note that, as the communication unit 31 to the storage 34, those having higher performance such as capacity and processing speed than the communication unit 21 to the storage 24 can be employed.

### <Functional Configuration Example of Server 12>

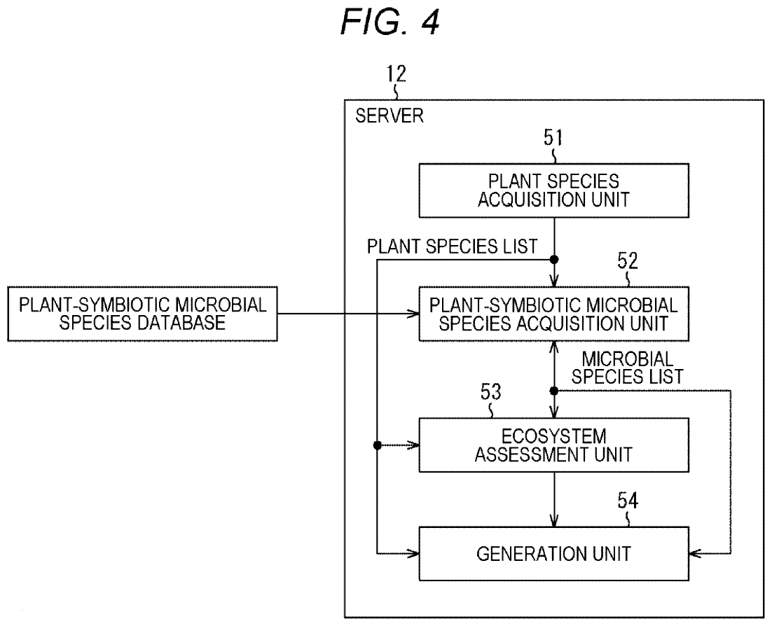

FIG. 4 is a block diagram illustrating a functional configuration example of the server 12.

The functional configuration of the server 12 is functionally implemented by the program executed by the calculation unit 32 in FIG. 3.

In FIG. 4, the server 12 includes a plant species acquisition unit 51, a plant-symbiotic microbial species acquisition unit 52, an ecosystem assessment unit 53, and a generation unit 54.

The plant species acquisition unit 51 acquires a plant species list.

For example, the plant species acquisition unit 51 receives and acquires the plant species list transmitted from the terminal 11. The plant species acquisition unit 51 provides the plant species list to the plant-symbiotic microbial species acquisition unit 52, the ecosystem assessment unit 53, and the generation unit 54.

The plant-symbiotic microbial species acquisition unit 52 acquires (the information regarding) plant-symbiotic microbial species symbiotic with predetermined plant species.

For example, the plant-symbiotic microbial species acquisition unit 52 consults the plant-symbiotic microbial species DB to detect and acquire plant-symbiotic microbial species associated with the plant species in the plant species list received from the plant species acquisition unit 51 in the plant-symbiotic microbial species DB. The plant-symbiotic microbial species acquisition unit 52 generates a microbial species list including plant-symbiotic microbial species symbiotic with the plant species in the plant species list, and provides the microbial species list to the ecosystem assessment unit 53 and the generation unit 54.

The ecosystem assessment unit 53 uses the plant-symbiotic microbial species in the microbial species list received from the plant-symbiotic microbial species acquisition unit 52 to assess the state of an ecosystem where the plant-symbiotic microbial species can thrive, that is, a target ecosystem where plant species (plant species in the plant species list) symbiotic with the plant-symbiotic microbial species exist.

For example, the ecosystem assessment unit 53 assesses the state of the target ecosystem on the basis of the functions of the plant-symbiotic microbial species in the microbial species list. For example, the ecosystem assessment unit 53 calculates, as an indicator of the state of the target ecosystem, indicator values of the functions of the plant-symbiotic microbial species in the microbial species list (for example, values representing the extent of carbon fixation, or the like) as an indicator value of the state of the target ecosystem using the functions of the plant-symbiotic microbial species.

Furthermore, for example, the ecosystem assessment unit 53 assesses the state of the target ecosystem on the basis of the (interspecies) interactions between the plant-symbiotic microbial species in the microbial species list and the other biological species. For example, the ecosystem assessment unit 53 calculates, as the indicator value of the state of the target ecosystem, indicator values of the functions of the plant-symbiotic microbial species based on the interactions with the other biological species (for example, humans and the like) (for example, a value representing the extent of intestinal regulation effects for humans).

Moreover, for example, the ecosystem assessment unit 53 calculates, as the indicator value of the state of the target ecosystem, an environmental economic value of the ecosystem functions of the target ecosystem using the plant-symbiotic microbial species in the microbial species list. For example, the ecosystem assessment unit 53 calculates, as the indicator value of the state of the target ecosystem, the environmental economic value of the ecosystem functions using a learning model (such as a regression model) that receives microbial diversity of the plant-symbiotic microbial species or the like as input and output the environmental economic value of the ecosystem functions.

Note that, for the assessment of the state of the target ecosystem, the ecosystem assessment unit 53 can use information obtained from the plant species list received from the plant species acquisition unit 51, such as diversity of plant species in the plant species list (hereinafter, also referred to as plant diversity).

The ecosystem assessment unit 53 provides, to the generation unit 54, the assessment result of the state of the target ecosystem, such as the indicator value of the state of the target ecosystem.

The generation unit 54 functions as a vegetation strategy generation unit that generates a vegetation strategy on the basis of the assessment result of the state of the target ecosystem received from the ecosystem assessment unit 53. Furthermore, the generation unit 54 functions as a presentation UI generation unit that generates an image as a presentation UI that presents the assessment result of the state of the target ecosystem, the vegetation strategy, and the like.

The generation unit 54 transmits the presentation UI to the terminal 11.

Note that, here, the server 12 generates the presentation UI that presents the assessment result of the state of the target ecosystem, the vegetation strategy, and the like and transmits the presentation UI to the terminal 11, and the terminal 11 receives and displays the presentation UI; however, the server 12 can transmit the assessment result of the state of the target ecosystem, the vegetation strategy, and the like instead of the presentation UI, to the terminal 11, and the terminal 11 can receive the assessment result of the state of the target ecosystem, the vegetation strategy, and the like, and generate and display the presentation UI that presents the assessment result of the state of the target ecosystem, the vegetation strategy, and the like.

### <Example of Outline of Processing of Server 12>

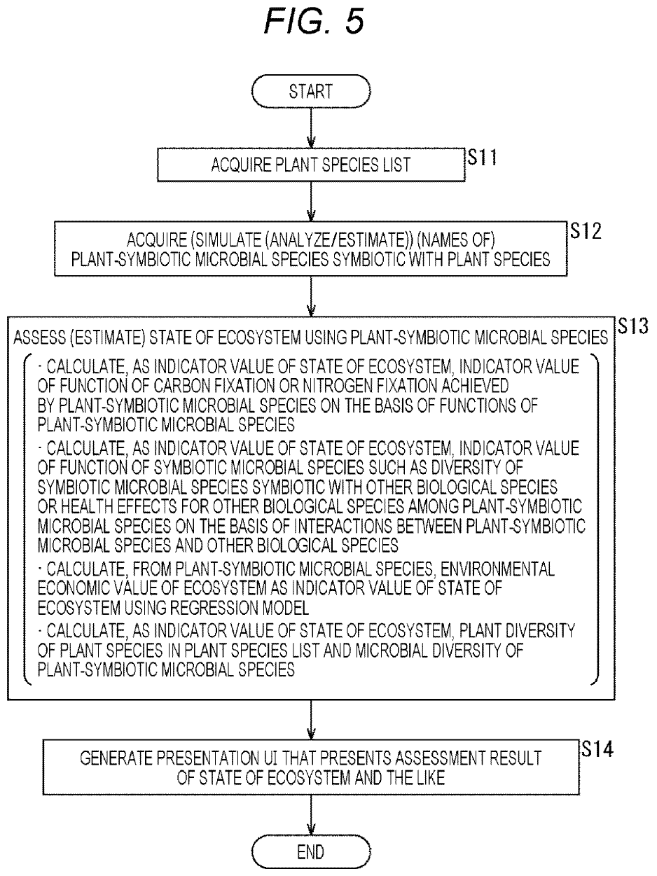

FIG. 5 is a flowchart illustrating an example of the outline of processing of the server 12.

In step S11, the plant species acquisition unit 51 receives and acquires a plant species list transmitted from the terminal 11, and provides the plant species list to the plant-symbiotic microbial species acquisition unit 52, the ecosystem assessment unit 53, and the generation unit 54, and the processing proceeds to step S12.

In step S12, the plant-symbiotic microbial species acquisition unit 52 consults the plant-symbiotic microbial species DB and acquires (simulate (analyze/estimate)) plant-symbiotic microbial species symbiotic with the plant species in the plant species list received from the plant species acquisition unit 51. The plant-symbiotic microbial species acquisition unit 52 generates a microbial species list including the plant-symbiotic microbial species, and provides the microbial species list to the ecosystem assessment unit 53 and the generation unit 54, and the processing proceeds from step S12 to step S13.

In step S13, the ecosystem assessment unit 53 assesses (estimates) the state of the target ecosystem using the plant-symbiotic microbial species in the microbial species list received from the plant-symbiotic microbial species acquisition unit 52.

For example, the ecosystem assessment unit 53 calculates, as the indicator value of the state of the target ecosystem, indicator values of the carbon fixation and nitrogen fixation functions of the plant-symbiotic microbial species on the basis of the functions of the plant-symbiotic microbial species.

Furthermore, for example, the ecosystem assessment unit 53 calculates, as the indicator value of the state of the target ecosystem, indicator values of the functions of symbiotic microbial species symbiotic with the other biological species, such as diversity of the symbiotic microbial species, among the plant-symbiotic microbial species, or health effects for the other biological species, a weighted sum of the indicator values of the functions, or the like on the basis of (the functions of the plant-symbiotic microbial species based on) interactions between the plant-symbiotic microbial species and the other biological species.

In addition, for example, the ecosystem assessment unit 53 can calculate, from the plant-symbiotic microbial species, the environmental economic value of the target ecosystem as the indicator value of the state of the target ecosystem using the regression model or the like. Furthermore, for example, the ecosystem assessment unit 53 can calculate, as the indicator value of the state of the ecosystem, the plant diversity of the plant species in the plant species list received from the plant species acquisition unit 51, the microbial diversity of the plant-symbiotic microbial species in the microbial species list received from the plant-symbiotic microbial species acquisition unit 52, the microbial diversity of some microbial species of the plant-symbiotic microbial species in the microbial species list, or the like.

For example, for each of two different plant species lists, it is possible to calculate some of the plant-symbiotic microbial species symbiotic with the plant species in the plant species list, for example, microbial diversity of human-symbiotic microbial species symbiotic with humans, or the like, as the indicator value of the state of the ecosystem. In this case, it is possible to simulate impacts on the human-symbiotic microbial species when the vegetation (plant species) changes from one to the other of the two plant species lists, such as whether the microbial diversity of the human-symbiotic microbial species will improve or decline.

The ecosystem assessment unit 53 provides, to the generation unit 54, the indicator value of the state of the target ecosystem as the assessment result of the state of the target ecosystem, and the processing proceeds from step S13 to step S14.

In step S14, the generation unit 54 generates an image as a presentation UI that presents the assessment result of the state of the target ecosystem and the like received from the ecosystem assessment unit 53, and transmits the image to the terminal 11, and the processing is brought to an end.

For example, the ecosystem assessment unit 53 calculates, as the indicator value of the state of the target ecosystem, indicator values of the functions of human-symbiotic microbial species such as diversity of the human-symbiotic microbial species symbiotic with humans (diversity of human gut microbiota or the like) among the plant-symbiotic microbial species or health effects (human health effects) for humans on the basis of interactions between the plant-symbiotic microbial species and the other biological species.

It has been reported that about 1300 kinds of human gut microbiota symbiotic with humans living in (or near) natural ecosystems, but humans living in urban areas of developed countries have lost about 30% of the human gut microbiota compared to humans living natural ecosystems.

Therefore, the diversity of human gut microbiota among plant-symbiotic microbial species can be an indicator used to assess the state of the ecosystem.

The server 12 acquires (estimates) the plant-symbiotic microbial species symbiotic with the plant species in the plant species list as microbial species that can thrive in the target ecosystem, and assesses the state of the target ecosystem using the plant-symbiotic microbial species; therefore, useful information can be obtained as the assessment result.

A healthy topsoil ecosystem, such as a topsoil ecosystem with higher-level diversity of human gut microbiota, has an ecosystem function (suppression function) of regulating the overgrowth of specific bacteria and viruses. As the assessment result of the target ecosystem, it is possible to obtain useful information regarding the management of the ecosystem for improving the ecosystem functions such as the suppression function.

For example, when the assessment result of the target ecosystem shows low diversity of human gut microbiota, it is possible to obtain information indicating that it is necessary to improve the diversity of human gut microbiota, that is, to newly introduce (plant) plant species symbiotic with the human gut microbiota and not currently introduced into the target ecosystem in order to improve the suppression function in the target ecosystem.

As described above, the server 12 uses the plant-symbiotic microbial species symbiotic with the plant species in the plant species list to assess the state of the target ecosystem where the plant species in the plant species list exist on the basis of interactions between the plant-symbiotic microbial species and the other biological species, for example.

Therefore, for example, the user can recognize how the state of the target ecosystem changes by transmitting a plurality of (types of) plant species lists including various plant species from the terminal 11 to the server 12 and confirming (the presentation UI that presents) the assessment result of the state of the target ecosystem transmitted from the server 12 for each of the plant species lists.

As a result, for example, in a case of making a tree planting plan, the user can perform a simulation as to what kind of plant species should be introduced to increase human health effects (public health benefits).

Furthermore, for example, the user can recognize what kind of plant species should be planted or what kind of seedlings should be transplanted as a specific action for improving the diversity of microbial species.

In a case of assessing the state of the target ecosystem for each of the plurality of plant species lists, the server 12 can propose a vegetation strategy for planting plant species in a plant species list with a higher specific indicator value, such as a plant species list with higher-level microbial diversity or a plant species list with a higher indicator value of human health effects in the assessment result of the state of the target ecosystem.

For example, the server 12 can generate a presentation UI that presents plant species in the plant species list with higher-level microbial diversity or the plant species list with a higher indicator value of human health effects as the vegetation strategy, and transmit the presentation UI to the terminal 11. In addition to the vegetation strategy, the presentation UI can include microbial diversity, the indicator value of human health effects, and the like as the assessment result of the state of the target ecosystem in a case where the vegetation strategy is implemented, for example.

### <Example of Plant Species List>

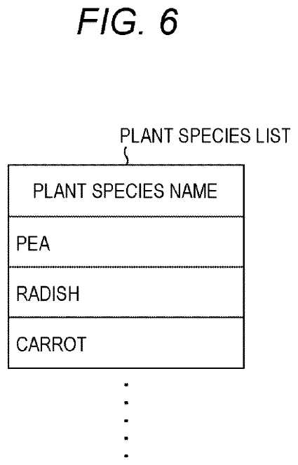

FIG. 6 is a diagram illustrating an example of the plant species list generated by the terminal 11.

The plant species list includes, for example, (the plant species name of) at least one plant species input by the user operating the terminal 11.

Furthermore, for example, the user can capture an image of plant species introduced into any place by operating the terminal 11. The terminal 11 analyzes the captured image and generates a plant species list including the plant species appearing in the image.

### <Example of Plant-Symbiotic Microbial Species DB>

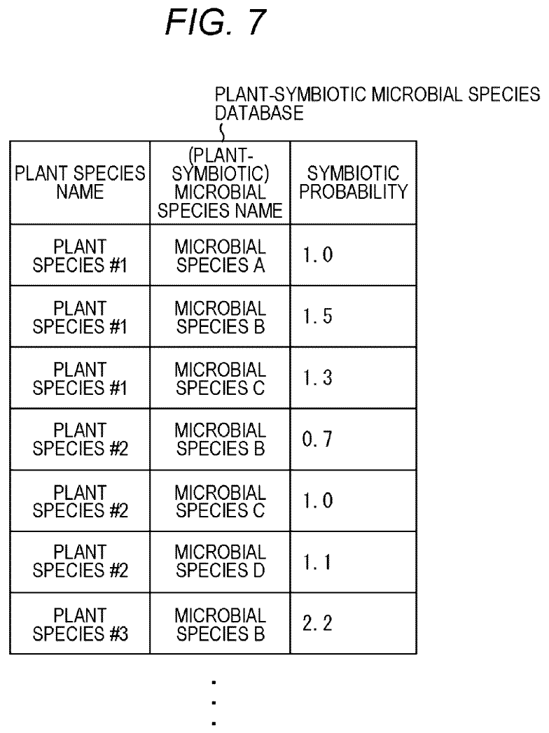

FIG. 7 is a diagram illustrating an example of the plant-symbiotic microbial species DB of the database 13.

The plant-symbiotic microbial species DB stores (the plant species names of) various plant species and (the microbial species names of) plant-symbiotic microbial species symbiotic with the plant species in association with each other.

In the plant-symbiotic microbial species DB in FIG. 7, not only the plant-symbiotic microbial species symbiotic with the plant species but also symbiotic probability is associated with the plant species.

The symbiotic probability indicates the probability that a microbial species in the “microbial species name” column is symbiotic with a plant species in the “plant species name” column, and can be set according to the number of documents reporting symbiosis between the microbial species and the plant species, for example. For example, in the real world, it is possible to update (correct), on the basis of whether or not a certain microbial species A is symbiotic with a certain plant species #1 (the plant species #1 attracts the microbial species A) through metagenomic analysis or the like, the symbiotic probability of symbiosis between the microbial species A and the plant species #1. It is possible to increase, by updating the symbiotic probability, the accuracy of the assessment (assessment of the state of the ecosystem) performed by the ecosystem assessment unit 53.

In the present embodiment, it is assumed that the higher the symbiotic probability, the higher the probability that the microbial species in the “microbial species name” column is symbiotic with the plant species in the “plant species name” column.

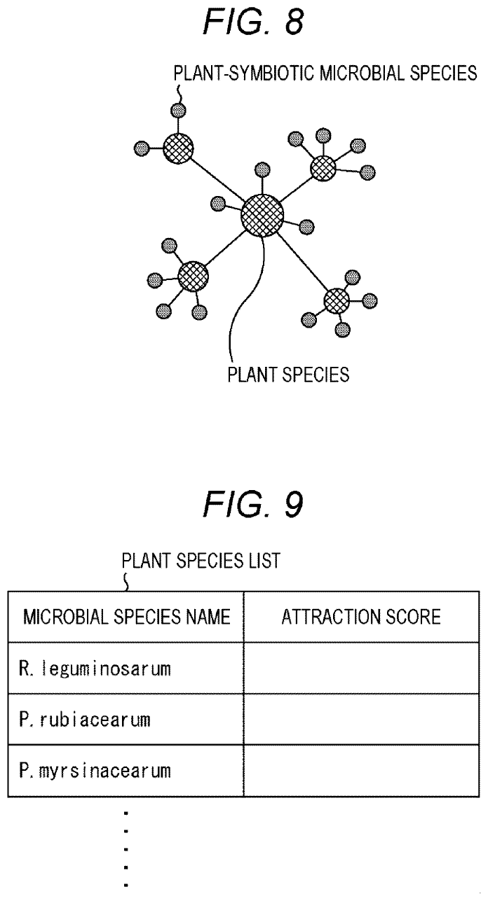

FIG. 8 is a diagram illustrating an example of a network graph showing relationships between plant species and plant-symbiotic microbial species associated with each other in the plant-symbiotic microbial species DB.

In the network graph in FIG. 8, nodes represented by large circles indicate the plant species in the plant species list, and nodes represented by small circles indicate the plant-symbiotic microbial species.

Links represented by lines connecting the plant species and the plant-symbiotic microbial species indicate symbiotic relationships between the plant species and the plant-symbiotic microbial species. Links represented by lines connecting the plant species indicate interactions between the plant species.

The plant-symbiotic microbial species acquisition unit 52 acquires (the microbial species names of) the plant-symbiotic microbial species associated with (the plant species names of) the plant species in the plant species list in the plant-symbiotic microbial species DB and acquires the symbiotic probability, as necessary.

Then, the plant-symbiotic microbial species acquisition unit 52 generates a microbial species list using the plant-symbiotic microbial species retrieved from the plant-symbiotic microbial species DB and using the symbiotic probability, as necessary, and provides the microbial species list to the ecosystem assessment unit 53.

### <Example of Microbial Species List>

FIG. 9 is a diagram illustrating an example of the microbial species list generated using the plant-symbiotic microbial species and the symbiotic probability.

The microbial species list includes (the microbial species names of) the plant-symbiotic microbial species acquired by the plant-symbiotic microbial species acquisition unit 52 from the plant-symbiotic microbial species DB.

In the microbial species list in FIG. 9, the plant-symbiotic microbial species are associated with attraction scores.

The attraction score indicates the probability that the plant-symbiotic microbial species are attracted by the plant species in the plant species list. As the attraction score of the microbial species A, for example, it is possible to use a sum total of (value obtained by normalizing) the symbiotic probability of symbiosis between each plant species in the plant species list and the microbial species A.

In the present embodiment, it is assumed that the higher the attraction score, the higher the probability that the corresponding plant-symbiotic microbial species is attracted.

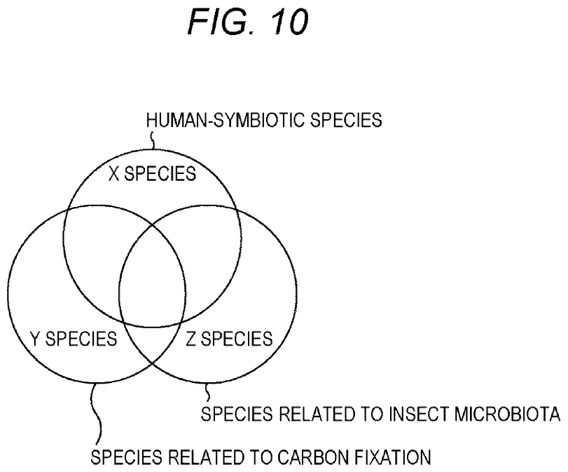

FIG. 10 is a diagram illustrating an example of a group of plant-symbiotic microbial species in the microbial species list.

The plant-symbiotic microbial species may include a group of microbial species symbiotic with humans (human-symbiotic species). Furthermore, the plant-symbiotic microbial species may include carbon-fixing microbial species (species related to carbon fixation), microbial species that interact with insects (microbiota) (species related to insect microbiota), and the like.

The microbial species belonging to each group may include microbial species belonging to one or more other groups.

### <First Configuration Example of Ecosystem Assessment Unit 53>

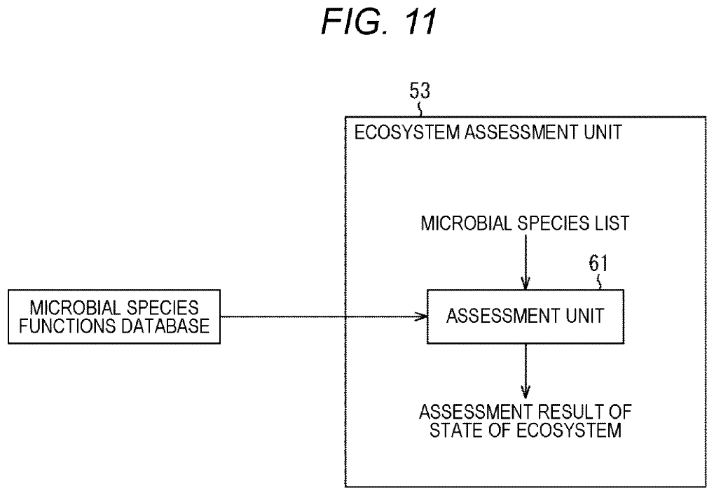

FIG. 11 is a block diagram illustrating a first configuration example of the ecosystem assessment unit 53.

In FIG. 11, the ecosystem assessment unit 53 includes an assessment unit 61.

The assessment unit 61 consults the microbial species functions DB, assesses the state of the ecosystem where the plant species in the plant species list exist on the basis of the interactions between the plant-symbiotic microbial species in the microbial species list received from the plant-symbiotic microbial species acquisition unit 52 and the other biological species, and outputs the assessment result of the state of the ecosystem.

In the microbial species functions DB, the functions of various microbial species are stored.

The functions of microbial species include functions based on interactions with the other biological species (for example, intestinal regulation effects for humans, improvement of immune function for humans, and the like).

It can be said that there is a relationship between microorganisms and the other biological species where the microbial species exert, through their functions, various effects (impacts) such as intestinal regulation effects and improvement of immune function on the other biological species such as humans.

The assessment unit 61 assesses the state of the ecosystem on the basis of the functions of the plant-symbiotic microbial species in the microbial species list including functions based on the interactions with the other biological species.

For example, the assessment unit 61 quantifies the functions based on the interactions of human-symbiotic microbial species having a symbiotic relationship with humans among the plant-symbiotic microbial species in the microbial species list, for example, the functions such as intestinal regulation effects for humans and improvement of immune function for humans. The assessment unit 61 outputs, as the indicator value of the state of the ecosystem, an indicator value obtained through quantification or a value (such as a weighted sum) calculated using the indicator value, such as an indicator value of health effects (effects on health) for humans arising from intestinal regulation effects, improvement of immune function, or the like.

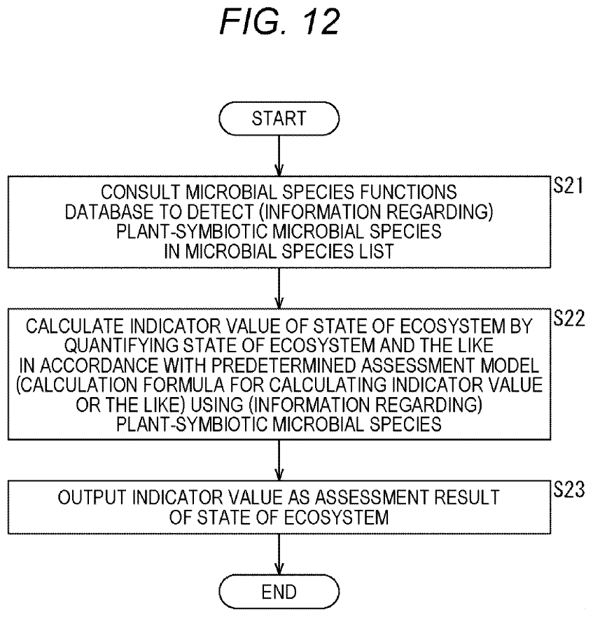

FIG. 12 is a flowchart for describing an example of processing of the assessment unit 61.

In step S21, the assessment unit 61 consults the microbial species functions DB to detect (the information regarding) the plant-symbiotic microbial species in the microbial species list, and the processing proceeds to step S22.

In step S22, the assessment unit 61 calculates an indicator value or the like of the state of the ecosystem obtained by quantifying the state of the ecosystem in accordance with a predetermined assessment model (a calculation formula or the like for calculating the indicator value) using (the information regarding) the plant-symbiotic microbial species detected in step S21, and the processing proceeds to step S23.

In step S23, the assessment unit 61 outputs the indicator value or the like of the state of the ecosystem as the assessment result of the state of the ecosystem, and the processing is brought to an end.

### <Example of Microbial Species Functions DB>

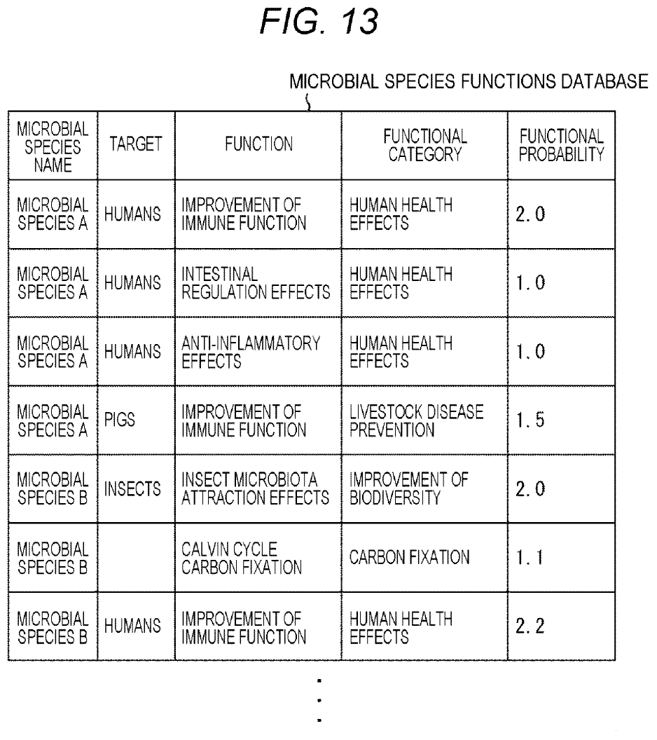

FIG. 13 is a diagram illustrating an example of the microbial species functions DB of the database 13.

The microbial species functions DB stores (the microbial species names of) various microbial species and (the names of) various functions including functions based on the interactions between the microbial species and the other biological species in association with each other.

In the microbial species functions DB in FIG. 13, the microbial species are associated with not only their functions but also targets, functional categories, and functional probability.

The target refers to another biological species (target biological species) that is affected (acted upon) by the functions based on the interactions with the other biological species.

The functional category refers to a classification (category) of the functions of microbial species (functions possessed by microbial species) based on common properties. In the present embodiment, for example, human health-related functions, such as improvement of immune function, intestinal regulation effects, and anti-inflammatory effects, belong to a functional category of human health effects. Furthermore, for example, livestock health-related functions, such as improvement of immune function for livestock such as pigs, belongs to a functional category of livestock disease prevention. The functional category is, in a sense, a higher-level concept of functions.

The functional probability indicates the probability that a microbial species (in the “microbial species name” column) possesses a function (in the “function” column), and can be set according to the number of documents reporting the function of the microbial species, for example. For example, in the real world, the functional probability of the function #1 of a certain microbial species A can be updated on the basis of whether or not the function #1 of the microbial species A has been verified. It is possible to increase, by updating the functional probability, the accuracy of the assessment performed by the ecosystem assessment unit 53. In the present embodiment, the higher the value of the functional probability, the higher the probability that the microbial species possesses the function.

### <Example of Processing of Plant-Symbiotic Microbial Species Acquisition Unit 52>

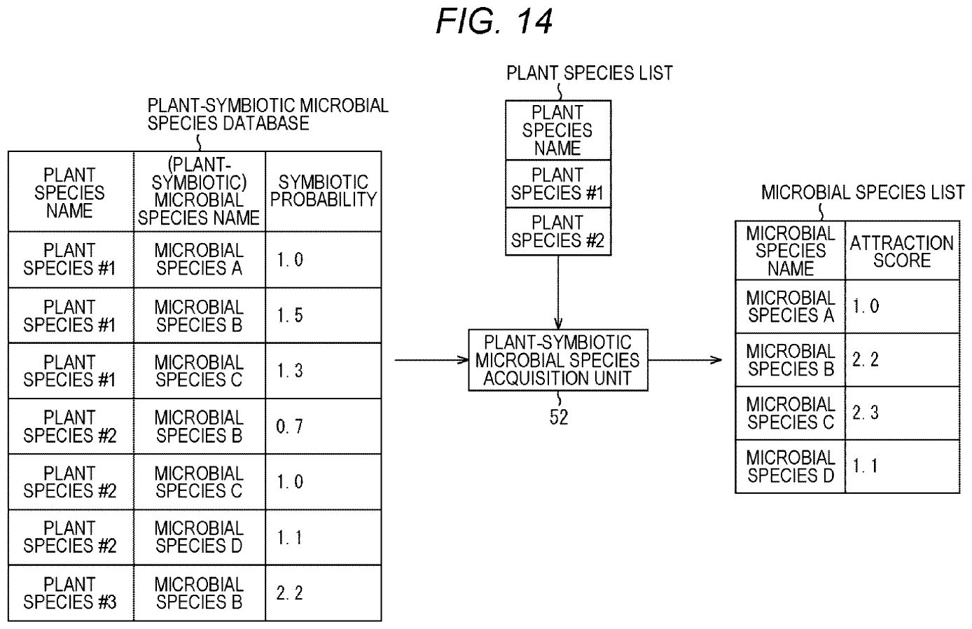

FIG. 14 is a diagram for describing an example of processing of the plant-symbiotic microbial species acquisition unit 52.

In other words, FIG. 14 illustrates an example of processing of the plant-symbiotic microbial species acquisition unit 52 in a case where the ecosystem assessment unit 53 is configured as illustrated in FIG. 11.

For example, the plant-symbiotic microbial species acquisition unit 52 consults the plant-symbiotic microbial species DB to detect plant-symbiotic microbial species associated with the plant species in the plant species list received from the plant species acquisition unit 51 in the plant-symbiotic microbial species DB.

The plant-symbiotic microbial species acquisition unit 52 calculates an attraction score indicating the extent to which the corresponding plant-symbiotic microbial species associated with the plant species in the plant species list is attracted by the plant species, using the symbiotic probability of the plant-symbiotic microbial species.

The plant-symbiotic microbial species acquisition unit 52 generates a microbial species list including the plant-symbiotic microbial species associated with the plant species in the plant species list and the attraction scores indicating the extent to which the plant-symbiotic microbial species are attracted and provides the microbial species list to the ecosystem assessment unit 53.

In the plant-symbiotic microbial species DB in FIG. 14, the microbial species A, B, and C associated with the plant species #1 are stored together with their respective symbiotic probabilities of 1.0, 1.5, and 1.3.

Furthermore, in the plant-symbiotic microbial species DB in FIG. 14, the microbial species B, C, and D associated with the plant species #2 are stored together with their respective symbiotic probabilities of 0.7, 1.0, and 1.1.

Moreover, in the plant-symbiotic microbial species DB in FIG. 14, the microbial species B associated with the plant species #3 is stored together with its symbiotic probability of 2.2.

For example, as illustrated in FIG. 14, in a case where the plant species #1 and #2 are included in the plant species list, the plant-symbiotic microbial species acquisition unit 52 detects the plant-symbiotic microbial species A, B, and C associated with the plant species #1 in the plant species list in the plant-symbiotic microbial species DB.

Moreover, the plant-symbiotic microbial species acquisition unit 52 detects the plant-symbiotic microbial species B and C associated with the plant species #2 in the plant species list in the plant-symbiotic microbial species DB.

Then, the plant-symbiotic microbial species acquisition unit 52 calculates, for example, a sum total of the symbiotic probabilities of the same plant-symbiotic microbial species among the plant-symbiotic microbial species associated with the plant species in the plant species list as the attraction score of the same plant-symbiotic microbial species.

As the attraction score of the plant-symbiotic microbial species A associated with the plant species #1 among the plant-symbiotic microbial species A, B, and C associated with the plant species #1 and the plant-symbiotic microbial species B and C associated with the plant species #2, 1.0, which is the sum total of the symbiotic probability of 1.0 of the plant-symbiotic microbial species A associated with the plant species #1, is calculated.

As the attraction score of the (same) plant-symbiotic microbial species B associated with the plant species #1 and #2, 2.2, which is the sum total of the symbiotic probability of 1.5 of the plant-symbiotic microbial species B associated with the plant species #1 and the symbiotic probability of 0.7 of the plant-symbiotic microbial species B associated with the plant species #2, is calculated.

As the attraction score of the (same) plant-symbiotic microbial species C associated with the plant species #1 and #2, 2.3, which is the sum total of the symbiotic probability of 1.3 of the plant-symbiotic microbial species C associated with the plant species #1 and the symbiotic probability of 1.0 of the plant-symbiotic microbial species C associated with the plant species #2, is calculated.

As the attraction score of the plant-symbiotic microbial species D associated with the plant species #2, 1.1, which is the sum total of the symbiotic probability of 1.1 of the plant-symbiotic microbial species D associated with the plant species #2, is calculated.

### <Example of Processing of Ecosystem Assessment Unit 53>

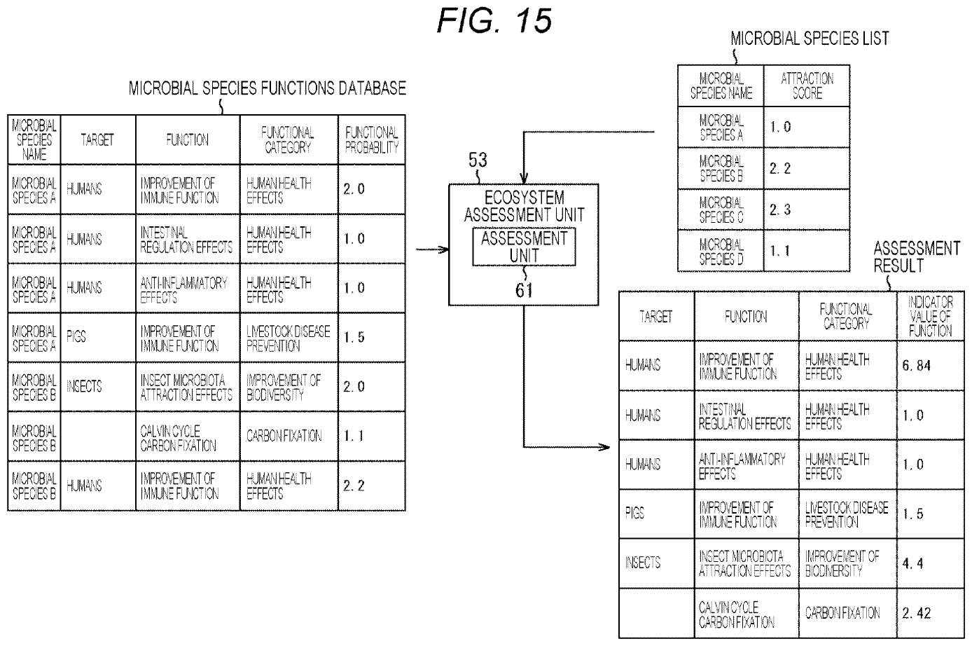

FIG. 15 is a diagram for describing an example of processing of the ecosystem assessment unit 53.

In other words, FIG. 15 illustrates an example of processing of the assessment unit 61 of the ecosystem assessment unit 53 in FIG. 11.

The assessment of the state of the ecosystem can be performed, for example, by quantifying the state of the ecosystem (converting the state of the ecosystem into a numerical form).

As the indicator value obtained by quantifying the state of the ecosystem (indicator value of the state of the ecosystem), for example, an indicator value obtained by quantifying (usefulness) of each function of the plant-symbiotic microbial species in the microbial species list (indicator value of the function) can be used.

As the indicator value of the state of the ecosystem, not only the indicator value of each function of the plant-symbiotic microbial species in the microbial species list (the indicator value of the function) but also, for example, a value such as (a value obtained by normalizing) a weighted sum calculated using some or all of the indicator values of each function of the plant-symbiotic microbial species in the microbial species list (the indicator values of the functions) or the like can be used.

For example, as the indicator value of the state of the ecosystem, a weighted sum calculated using all the indicator values of the functions of the plant-symbiotic microbial species in the microbial species list or the like can be used.

Moreover, for example, as the indicator value of the state of the ecosystem, an indicator value of each functional category (indicator value of the functional category), in other words, a weighted sum calculated for each functional category using the indicator values of the functions belonging to the functional category or the like can be used.

Furthermore, as the indicator value of the state of the ecosystem, it is possible to use plant diversity (for example, the number of species) of all the plant species in the plant species list or some plant species such as plant species symbiotic with microbial species having specific functions, microbial diversity of all the plant-symbiotic microbial species in the microbial species list or some microbial species such as microbial species having specific functions, diversity of biological species including the plant species in the plant species list and the plant-symbiotic microbial species in the microbial species list, any value that can be used to assess the state of the ecosystem, or the like.

The indicator value of the state of the ecosystem can also be regarded as an indicator value of ecosystem functions (ecosystem service) of the ecosystem.

Note that the assessment method for assessing the state of the ecosystem can be appropriately set on the basis of the construction purpose of constructing the ecosystem or the like. That the assessment method is set refers to, for example, that assessment-related factors such as indicators used to assess the state of the ecosystem (such as the functions of microorganisms, microbial diversity, plant diversity, environmental economic value of the ecosystem, and the like), the weight of the weighted sum of the indicator values of the functions, and the calculation method (such as a calculation formula or a model used for calculation) for calculating the indicator values are set.

For example, in a case where the construction purpose is to promote human health, the weight of the functions belonging to the functional category of human health effects can be set to a large value (for example, 1), and the weight of the other functions can be set to a small value (for example, 0).

Furthermore, for example, regarding human health, particularly, in a case where the construction purpose is to improve immune function, among the functions belonging to the functional category of human health effects, the weight of the function of improving immune function can be set to a large value, the weight of the other functions can be set to a medium value (for example, 0.5), and the weight of the functions belonging to functional categories other than the functional category of human health effects can be set to a small value (for example, 0).

In FIG. 15, as the indicator value of the state of the ecosystem, the indicator value of each function of the plant-symbiotic microbial species in the microbial species list is calculated.

In FIG. 15, the microbial species list includes the plant-symbiotic microbial species A, B, C, and D together with their respective attraction scores of 1.0, 2.2, 2.3, and 1.1. The attraction scores of 1.0, 2.2, 2.3, and 1.1 of the plant-symbiotic microbial species A, B, C, and D are values calculated as described with reference to FIG. 14.

Furthermore, in FIG. 15, in the microbial species functions DB, as the functions of the microbial species A, improvement of immune function, intestinal regulation effects, and anti-inflammatory effects for humans are stored together with their respective functional probabilities of 2.0, 1.0, and 1.0.

Moreover, as the function of the microbial species A, improvement of immune function for pigs is stored together with its functional probability of 1.5.

Furthermore, as the functions of the microbial species B, insect microbiota attraction effects for insects and improvement of immune function for humans are stored together with their respective functional probabilities of 2.0 and 2.2.

In addition, as the function of the microbial species B, (calvin cycle) carbon fixation is stored together with its functional probability of 1.1.

The assessment unit 61 calculates, as the indicator value of each function, a sum total of values obtained by multiplying the functional probability of the function by the attraction score of the plant-symbiotic microbial species having the function as a coefficient, for example.

In FIG. 15, as the functions of the plant-symbiotic microbial species A among the plant-symbiotic microbial species A, B, C, and D in the microbial species list, improvement of immune function, intestinal regulation effects, and anti-inflammatory effects for humans, and improvement of immune function for pigs are stored in the microbial species functions DB.

Moreover, as the functions of the plant-symbiotic microbial species B, insect microbiota attraction effects for insects, carbon fixation, and improvement of immune function for humans are stored in the microbial species functions DB.

Here, to simplify the description, it is assumed that the functions of the plant-symbiotic microbial species C and D are not stored in the microbial species functions DB.

In this case, as the functions of the plant-symbiotic microbial species in the microbial species list, there are six (types) of functions: improvement of immune function, intestinal regulation effects, and anti-inflammatory effects for humans, improvement of immune function for pigs, insect microbiota attraction effects for insects, and carbon fixation, and therefore, indicator values of these six functions are calculated.

The functional probabilities of 2.0 and 2.2 of the function “improvement of immune function for humans” of the plant-symbiotic microbial species A and B in the microbial species list are multiplied by the attraction scores of 1.0 and 2.2 of the plant-symbiotic microbial species A and B as coefficients, respectively, thereby obtaining, as the indicator value of the function “improvement of immune function for humans”, a sum total of the multiplied values 1.0×2.0 and 2.2×2.2, which is 6.84, for the same function “improvement of immune function for humans”.

The functional probability of 1.0 of the function “intestinal regulation effects for humans” of the plant-symbiotic microbial species A in the microbial species list is multiplied by the attraction score of 1.0 of the plant-symbiotic microbial species A as a coefficient, thereby obtaining, as the indicator value of the function “intestinal regulation effects for humans”, a sum total of the multiplied value 1.0×1.0, which is 1.0, for the same function “intestinal regulation effects for humans”.

The indicator values of the other functions of the plant-symbiotic microbial species in the microbial species list, including “anti-inflammatory effects for humans”, “improvement of immune function for pigs”, “insect microbiota attraction effects for insects”, and “carbon fixation” are calculated in a similar manner.

The assessment unit 61 can output, as the indicator value of the state of the ecosystem, each of the indicator values of the six functions of the plant-symbiotic microbial species in the microbial species list, including “improvement of immune function for humans”, “intestinal regulation effects for humans”, “anti-inflammatory effects for humans”, “improvement of immune function for pigs”, “insect microbiota attraction effects for insects”, and “carbon fixation”.

Furthermore, the assessment unit 61 can calculate a weighted sum of the indicator values of the six functions “improvement of immune function for humans”, “intestinal regulation effects for humans”, “anti-inflammatory effects for humans”, “improvement of immune function for pigs”, “insect microbiota attraction effects for insects”, and “carbon fixation”, and output the weighted sum as the indicator value of the state of the ecosystem.

For example, the assessment unit 61 can output a weighted sum calculated with the weight of each of the six functions “improvement of immune function for humans”, “intestinal regulation effects for humans”, “anti-inflammatory effects for humans”, “improvement of immune function for pigs”, “insect microbiota attraction effects for insects”, and “carbon fixation” set to 1 as the indicator value of the state of the ecosystem

Furthermore, for example, the assessment unit 61 can output a weighted sum calculated with the weight of each of the functions of “improvement of immune function for humans”, “intestinal regulation effects for humans”, and “anti-inflammatory effects for humans” belonging to the functional category of “human health effects” set to 1, and the weight of each of the other functions set to 0 as the indicator value of the state of the ecosystem

In this case, the indicator value of the state of the ecosystem indicates (positive) impacts of the state of the ecosystem on human health effects.

Therefore, in this case, impacts of the ecosystem where the microorganisms in the microbial species list (plant-symbiotic microbial species symbiotic with the plant species in the plant species list) exist on human health effects can be simulated. In addition, it is possible to simulate impacts of the weight setting method on biological species other than humans.

Furthermore, the assessment unit 61 can output, as the indicator value of the state of the ecosystem, a weighted sum calculated using the indicator values of functional categories, for example, the indicator values of the functions belonging to each of the functional categories.

Among the six functions “improvement of immune function for humans”, “intestinal regulation effects for humans”, “anti-inflammatory effects for humans”, “improvement of immune function for pigs”, “insect microbiota attraction effects for insects”, and “carbon fixation”, the functions “improvement of immune function for humans”, “intestinal regulation affects for humans”, and “anti-inflammatory effects for humans” belong to the functional category “human health effects”. The functions “improvement of immune function for pigs”, “insect microbiota attraction effects for insects”, and “carbon fixation” belong to the functional categories “livestock disease prevention”, “improvement of biodiversity”, and “carbon fixation”, respectively.

In this case, the assessment unit 61 calculates the indicator values of the functional categories “human health effects”, “livestock disease prevention”, “improvement of biodiversity”, and “carbon fixation”.

As the indicator value of the functional category “human health effects”, a sum total of the indicator values of the functions “improvement of immune function for humans”, “intestinal regulation effects for humans”, and “anti-inflammatory effects for humans” belonging to the functional category “human health effects” is calculated.

As the indicator values of the functional categories “livestock disease prevention”, “improvement of biodiversity”, and “carbon fixation”, the indicator values of the functions “improvement of immune function for pigs”, “insect microbiota attraction effects for insects”, and “carbon fixation” belonging to “livestock disease prevention”, “improvement of biodiversity”, and “carbon fixation” are calculated, respectively.

The assessment unit 61 can output the indicator values of the functional categories “human health effects”, “livestock disease prevention”, “improvement of biodiversity”, and “carbon fixation” calculated as described above as the indicator value of the state of the ecosystem.

### <Example of Processing of Ecosystem Assessment Unit 53>

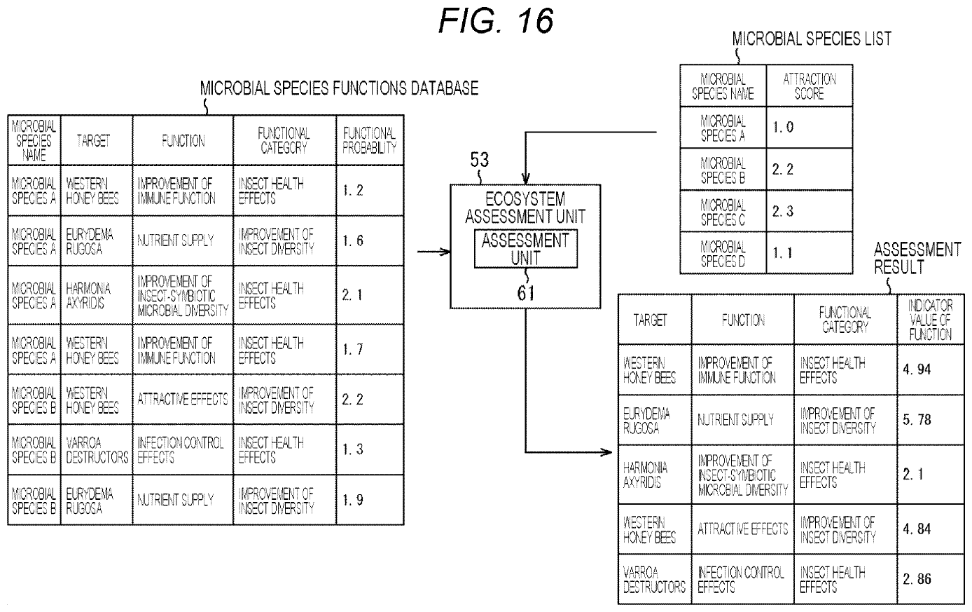

FIG. 16 is a diagram for describing an example of processing of the ecosystem assessment unit 53.

In other words, FIG. 16 illustrates an example of processing of the assessment unit 61 of the ecosystem assessment unit 53 in FIG. 11.

For example, it is assumed that the plant species #1 and #2 are now included in the plant species list, and the plant-symbiotic microbial species acquisition unit 52 has generated, as described in FIG. 14, the microbial species list including the plant-symbiotic microbial species A, B, C, and D symbiotic with at least one of the plant species #1 or #2 together with the attraction scores of 1.0, 2.2, 2.3, and 1.1.

As illustrated in FIG. 16, in the microbial species functions DB, the functions of microbial species based on interactions between the microbial species and insects are stored.

For example, in the microbial species functions DB in FIG. 16, as the functions of the microbial species A, improvement of immune function for western honey bees, nutrient supply for Eurydema rugosa, and improvement of insect-symbiotic microbial diversity for Harmonia axyridis are stored together with their respective functional probabilities of 1.2, 1.6, and 2.1.

Furthermore, as the functions of the microbial species B, improvement of immune function for western honey bees, attractive effects for western honey bees, infection control effects for Varroa destructors, and nutrient supply for Eurydema rugosa are stored together with the their respective functional probabilities of 1.7, 2.2, 1.3, and 1.9.

Here, to simplify the description, it is assumed that the functions of the plant-symbiotic microbial species C and D are not stored in the microbial species functions DB.

In FIG. 16, as the functions of the plant-symbiotic microbial species in the microbial species list, there are five functions: improvement of immune function for western honey bees, nutrient supply for Eurydema rugosa, improvement of insect-symbiotic microbial diversity for Harmonia axyridis, attractive effects for western honey bees, and infection control effects for Varroa destructors. The assessment unit 61 calculates the indicator values of the five functions, for example.

As described with reference to FIG. 15, the assessment unit 61 calculates, as the indicator value of each function, a sum total of values obtained by multiplying the functional probability of the function by the attraction score of the plant-symbiotic microbial species having the function as a coefficient.

The functional probabilities of 1.2 and 1.7 of the function “improvement of immune function for western honey bees” of the plant-symbiotic microbial species A and B in the microbial species list are multiplied by the attraction scores of 1.0 and 2.2 of the plant-symbiotic microbial species A and B as coefficients, thereby obtaining, as the indicator value of the function “improvement of immune function for western honey bees”, a sum total of the multiplied values 1.0×1.2 and 2.2×1.7, which is 4.94, for the same function “improvement of immune function for western honey bees”.

The functional probabilities of 1.6 and 1.9 of the function “nutrient supply for Eurydema rugosa” of the plant-symbiotic microbial species A and B in the microbial species list are multiplied by the attraction scores of 1.0 and 2.2 of the plant-symbiotic microbial species A and B as coefficients, thereby obtaining, as the indicator value of the function “nutrient supply for Eurydema rugosa”, a sum total of the multiplied values 1.0×1.6 and 2.2×1.9, which is 5.78, for the same function “nutrient supply for Eurydema rugosa”.

The indicator values of the other functions of the plant-symbiotic microbial species in the microbial species list, that is, “improvement of insect-symbiotic microbial diversity for Harmonia axyridis”, “attractive effects for western honey bees”, and “infection control effects for Varroa destructors” are calculated in a similar manner.

The assessment unit 61 can output, as the indicator value of the state of the ecosystem, the indicator value of each of the five functions of the plant-symbiotic microbial species in the microbial species list: “improvement of immune function for western honey bees”, “nutrient supply for Eurydema rugosa”, “improvement of insect-symbiotic microbial diversity for Harmonia axyridis”, “attractive effects for western honey bees”, and “infection control effects for Varroa destructors”.

Furthermore, the assessment unit 61 can calculates a weighted sum of the indicator values each of the five functions: “improvement of immune function for western honey bees”, “nutrient supply for Eurydema rugosa”, “improvement of insect-symbiotic microbial diversity for Harmonia axyridis”, “attractive effects for western honey bees”, and “infection control effects for Varroa destructors”, and output the weighted sum as the indicator value of the state of the ecosystem.

For example, the assessment unit 61 can output, as the indicator value of the state of the ecosystem, a weighted sum calculated with the weight of each of the five functions: “improvement of immune function for western honey bees”, “nutrient supply for Eurydema rugosa”, “improvement of insect-symbiotic microbial diversity for Harmonia axyridis”, “attractive effects for western honey bees”, and “infection control effects for Varroa destructors” set to 1.

In FIG. 16, since the functions of the microbial species based on interactions between the microbial species and insects are stored in the microbial species functions DB, it can be said that the indicator value of the state of the ecosystem obtained by calculating a weighted sum with the weight of each of the five functions: “improvement of immune function for western honey bees”, “nutrient supply for Eurydema rugosa”, “improvement of insect-symbiotic microbial diversity for Harmonia axyridis”, “attractive effects for western honey bees”, and “infection control effects for Varroa destructors” set to 1 is an indicator value related to the insects (microbiota) of the ecosystem.

For example, the assessment unit 61 can output, as the indicator value of the state of the ecosystem, a weighted sum calculated with the weight of each of the functions belonging to a functional category “insect health effects” set to 1, the functions including “improvement of immune function for western honey bees”, “improvement of insect-symbiotic microbial diversity for Harmonia axyridis”, and “infection control effects for Varroa destructors”, and the weight of the other functions set to 0.

In this case, the indicator value of the state of the ecosystem indicates (positive) impacts of the state of the ecosystem on insect health effects.

Furthermore, the assessment unit 61 can output, as the indicator value of the state of the ecosystem, a weighted sum calculated using the indicator values of functional categories, for example, the indicator values of the functions belonging to each of the functional categories.

Among the five functions “improvement of immune function for western honey bees”, “nutrient supply for Eurydema rugosa”, “improvement of insect-symbiotic microbial diversity for Harmonia axyridis”, “attractive effects for western honey bees”, and “infection control effects for Varroa destructors”, the functions “improvement of immune function for western honey bees”, “improvement of insect-symbiotic microbial diversity for Harmonia axyridis”, and “infection control effects for Varroa destructors” belong to the functional category “insect health effects”. The functions “nutrient supply for Eurydema rugosa” and “attractive effects for western honey bees” each belong to a functional category “improvement of insect diversity”.

In this case, the assessment unit 61 calculates the indicator values of the functional categories “insect health effects” and “improvement of insect diversity”.

As the indicator value of the functional category “insect health effects”, a sum total (a weighted sum with all the weights set to 1) of the indicator values of the functions: “improvement of immune function for western honey bees”; “improvement of insect-symbiotic microbial diversity for Harmonia axyridis”; and “infection control effects for Varroa destructors”, belonging to the functional category “insect health effects” is calculated.

As the indicator value of the functional category “improvement of insect diversity”, a sum total of the indicator values of the functions: “nutrient supply for Eurydema rugosa”; and “attractive effects for western honey bees”, belonging to “improvement of insect diversity” is calculated.

The assessment unit 61 can output the indicator values of the functional categories “insect health effects”, and “improvement of insect diversity” calculated as described above as the indicator value of the state of the ecosystem.

### <Second Configuration Example of Ecosystem Assessment Unit 53>

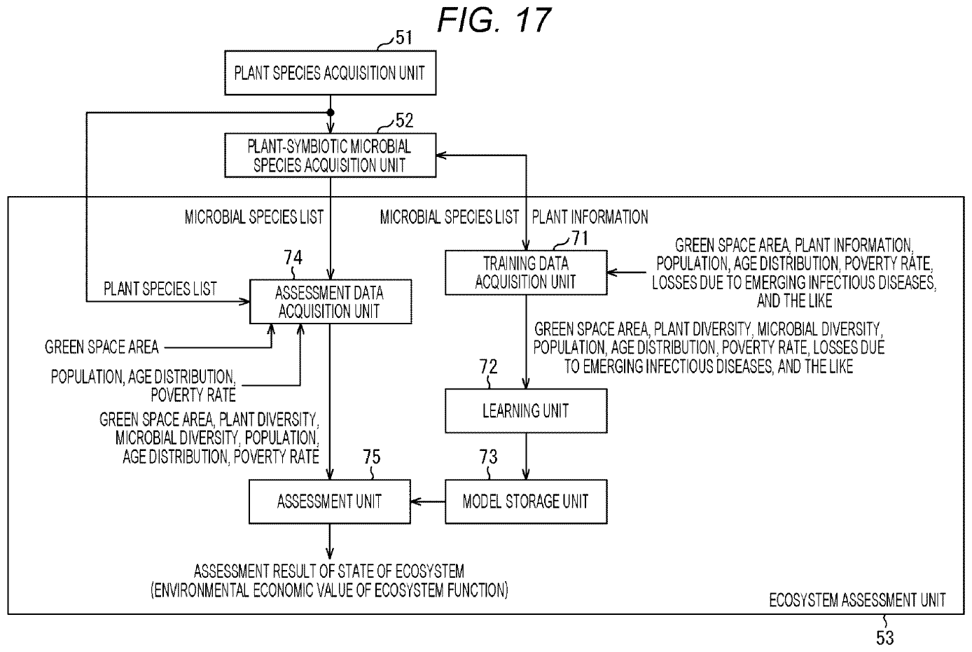

FIG. 17 is a block diagram illustrating a second configuration example of the ecosystem assessment unit 53.

In FIG. 17, the ecosystem assessment unit 53 includes a training data acquisition unit 71, a learning unit 72, a model storage unit 73, an assessment data acquisition unit 74, and an assessment unit 75.

The ecosystem assessment unit 53 in FIG. 17 calculates the environmental economic value of the ecosystem functions of the ecosystem as the indicator value (assessment result) of the state of the ecosystem using the plant-symbiotic microbial species in the microbial species list.

The training data acquisition unit 71 acquires training data used for training a learning model stored in the model storage unit 73.

For example, the training data acquisition unit 71 acquires, from, for example, a server or the like on the Internet, green space area, plant information, population, age distribution, poverty rate, economic losses due to emerging infectious diseases, and the like in various countries and regions around the world.

The plant information of each region is information regarding plant species existing in the region. The economic losses due to emerging infectious diseases is released by the World Health Organization.

The training data acquisition unit 71 provides the plant information of each region to the plant-symbiotic microbial species acquisition unit 52. The plant-symbiotic microbial species acquisition unit 52 acquires plant-symbiotic microbial species symbiotic with the plant species indicated by the plant information of each region received from the training data acquisition unit 71, and generates a microbial species list including microbial species that can thrive in each region. Then, the plant-symbiotic microbial species acquisition unit 52 provides the microbial species list of each region to the training data acquisition unit 71.

The training data acquisition unit 71 calculates plant diversity of each region from the plant information of each region. Moreover, the training data acquisition unit 71 calculates microbial diversity of each region from the microbial species list of each region received from the plant-symbiotic microbial species acquisition unit 52.

Then, the training data acquisition unit 71 provides multivariate data such as the green space area, plant diversity, microbial diversity, population, age distribution, poverty rate, and economic losses due to emerging infectious diseases of each region to the learning unit 72 as training data.

The learning unit 72 trains the learning model stored in the model storage unit 73 using the training data received from the training data acquisition unit 71.

The learning unit 72 trains the learning model using the economic losses due to emerging infectious diseases of each region of the training data as output and the other training data, here, for example, the green space area, plant diversity, microbial diversity, population, age distribution, and poverty rate of each region as input.

As the input of the learning model, not only the green space area, plant diversity, microbial diversity, population, age distribution, and poverty rate of each region, but also any desired information regarding the ecosystem of each region, such as weather information, can be used.

For example, the learning unit 72 trains the learning model such as a regression model using the economic losses due to emerging infectious diseases of each region as a response variable, and the green space area, plant diversity, microbial diversity, population, age distribution, and poverty rate of each region as explanatory variables. Note that, as the learning model, a model other than the regression model, such as a neural network, can be employed.

The learning unit 72 provides (the parameters of) the regression model as a trained learning model to the model storage unit 73.

The model storage unit 73 stores the regression model as the trained learning model received from the learning unit 72.

Note that, in a case where a new emerging infectious disease spreads, and economic losses due to the emerging infectious disease are newly announced, the learning model stored in the model storage unit 73 can be retrained using the newly released economic losses due to the emerging infectious disease and the like.

The assessment data acquisition unit 74 acquires assessment data used for assessing the state of the ecosystem, that is, assessment data used for calculating the environmental economic value of the ecosystem functions of the ecosystem as the indicator value of the state of the ecosystem.

Here, the user inputs, into the terminal 11, plant species existing in a region (location) for which the user wants to know the environmental economic value of the ecosystem functions, and the terminal 11 generates a plant species list including the position of (information regarding) the region together with the plant species, and transmits the plant species list to the server 12.

Here, the region whose position is included in the plant species list is a target region for which the environmental economic value of the ecosystem functions is calculated as the indicator of the state of the ecosystem, and is hereinafter also referred to as target region.

In the server 12, the plant species acquisition unit 51 receives the plant species list from the terminal 11 and provides the plant species list to the plant-symbiotic microbial species acquisition unit 52, the ecosystem assessment unit 53, and the assessment data acquisition unit 74.

The plant-symbiotic microbial species acquisition unit 52 acquires plant-symbiotic microbial species symbiotic with the plant species included in the plant species list received from the plant species acquisition unit 51 as microbial species existing in the target region, and provides a microbial species list including the microbial species (plant-symbiotic microbial species) existing in the target region to the assessment data acquisition unit 74.

The assessment data acquisition unit 74 acquires, from, for example, a server or the like on the Internet, the green space area, population, age distribution, and poverty rate of the target region whose position is included in the plant species list received from the plant species acquisition unit 51 as the assessment data.

The assessment data acquisition unit 74 calculates, as the assessment data, the plant diversity of the target region from the plant species list received from the plant species acquisition unit 51. Moreover, the assessment data acquisition unit 74 calculates, as assessment data, the microbial diversity of the target region from the microbial species list received from the plant-symbiotic microbial species acquisition unit 52.

The assessment data acquisition unit 74 provides, to the assessment unit 75, the green space area, plant diversity, microbial diversity, population, age distribution, and poverty rate of the target region as the assessment data.

The assessment unit 75 calculates a predicted value of the economic losses due to emerging infectious diseases of the target region as the environmental economic value of the ecosystem functions of (the ecosystem of) the target region by inputting the green space area, plant diversity, microbial diversity, population, age distribution, and poverty rate of the target region as the assessment data received from the assessment data acquisition unit 74 into the regression model as the learning model stored in the model storage unit 73.

Then, the assessment unit 75 outputs the environmental economic value of the ecosystem functions of the target region as the indicator value (assessment result) of the state of the ecosystem of the target region.

Here, since (the predicted value of) the economic losses due to emerging infectious diseases of the target region is employed as the environmental economic value of the ecosystem function of the target region, the smaller the value (losses), the larger the environmental economic value of the ecosystem functions of the target region.

Note that the plant-symbiotic microbial species acquisition unit 52 acquires plant-symbiotic microbial species symbiotic with the plant species included in the plant species list as microbial species existing in the target region, but the microbial species existing in the target region can be acquired through, for example, analysis of samples collected from the real world.

For example, the user can collect samples from the target region in the real world, send the samples to an analysis company for metagenomic analysis or the like, and request the analysis company to transmit, to the terminal 11, a microbial species list including microbial species existing in the target region obtained through the metagenomic analysis.

In this case, the terminal 11 can transmit the microbial species list received from the analysis company to the server 12. In the server 12, the plant-symbiotic microbial species acquisition unit 52 can receive and acquire the microbial species list from the terminal 11, and provides the microbial species list to the assessment data acquisition unit 74.

Here, although the user inputs the plant species existing in the target region into the terminal 11, the user can input other plant species partially or completely different from the plant species existing in the target region.

In this case, the ecosystem assessment unit 53 calculates, as the indicator value of the state of the ecosystem of the target region, the environmental economic value of the ecosystem functions of the target region in a case where the plant species in the target region are changed from the currently existing plant species to different plant species. It can be said that the ecosystem assessment unit 53 constitutes an environmental economic simulator with the impacts of changes in vegetation on the microbial diversity in the space (the impacts of changes in existing plant species on the microbial species in the space) and resilience during infectious disease outbreaks taken into account.

Note that the ecosystem assessment unit 53 may have both the configuration in FIG. 11 and the configuration in FIG. 17.

### <Proposal of Vegetation Strategy>

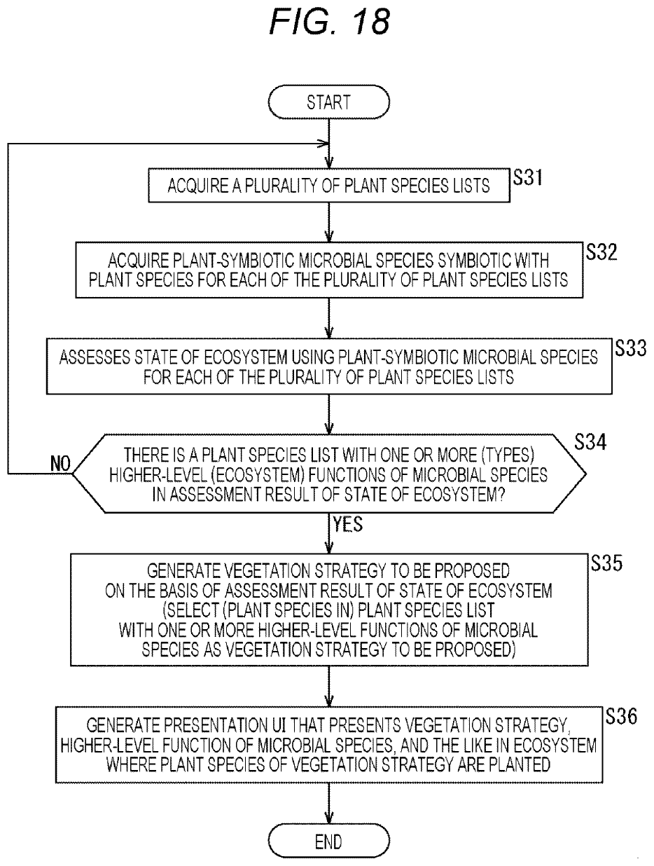

FIG. 18 is a flowchart illustrating an example of processing of the server 12 in a case where a vegetation strategy is proposed on the basis of the assessment result of the state of the ecosystem.

In step S31, the plant species acquisition unit 51 acquires a plurality of plant species lists, and provides the plurality of plant species lists to the plant-symbiotic microbial species acquisition unit 52, the ecosystem assessment unit 53, and the generation unit 54, and the processing proceeds to step S32.

For example, the plant species acquisition unit 51 can receive one plant species list transmitted from the terminal 11, such as a plant species list including plant species introduced into the (target) ecosystem, and generates the plurality of plant species lists on the basis of the plant species list. For example, the plant species acquisition unit 51 can generate the plurality of plant species lists by adding plant species to the plant species list received from the terminal 11 or deleting or changing some plant species in the plant species list.

Furthermore, in a case where the user, as a vegetation strategy expert and consultant, proposes, in response to a consultation from the client, a vegetation strategy aligned with the client's construction purpose, the user as a consultant inputs a plurality of sets of plant species expected to construct an ecosystem aligned with the client's construction purpose into the terminal 11.

Here, the user as a consultant inputs, according to construction purposes from other clients, such as improvement of insect diversity and improvement of immune function for humans, a plurality of sets of plant species expected to construct ecosystems aligned with the construction purposes into the terminal 11,

For example, in a case where the user as a consultant receives a consultation from a client about green space planning of a hospital facility, the user identifies and inputs, into the terminal 11, a plurality of sets of plant species expected to improve microbial diversity in the space and facilitate the symbiosis of microorganisms, especially those that can thrive in the human gut.

Moreover, for example, in a case where the construction purpose is to promote nitrogen fixation, the user as a consultant identifies and inputs, into the terminal 11, a plurality of sets of plant species expected to facilitate the growth (symbiosis) of nitrogen-fixing bacteria.

Furthermore, for example, in a case where the construction purpose is to prioritize carbon fixation (accelerating the carbon fixation cycle through the growth of plant species, the promotion of soil ecosystem cycle, or the like), the user as a consultant identifies and inputs, into the terminal 11, a plurality of sets of plant species that facilitate the growth of carbon-fixing microbial species and plant species that absorb a large amount of carbon dioxide and attract insect microbiota by serving as a food source.

The terminal 11 generates a plurality of plant species lists including the plant species of each set input by the user as a consultant, and transmits the plurality of plant species lists to the server 12.

For example, the plant species acquisition unit 51 receives and acquires the plurality of plant species lists transmitted from the terminal 11.

In step S32, the plant-symbiotic microbial species acquisition unit 52 consults the plant-symbiotic microbial species DB to acquire plant-symbiotic microbial species symbiotic with the plant species in each of the plurality of plant species lists received from the plant species acquisition unit 51. The plant-symbiotic microbial species acquisition unit 52 generates a microbial species list including plant-symbiotic microbial species for each of the plurality of plant species lists, and provides the microbial species list to the ecosystem assessment unit 53 and the generation unit 54, and the processing proceeds from step S32 to step S33.

In step S33, (the assessment unit 61 of) the ecosystem assessment unit 53 assesses, for each of the plurality of plant species lists, the state of the (target) ecosystem using the plant-symbiotic microbial species in the microbial species list received from the plant-symbiotic microbial species acquisition unit 52, in a manner similar to step S22 in FIG. 12, and the processing proceeds to step S34.

In step S34, the ecosystem assessment unit 53 determines whether or not there is a plant species list with one or more higher-level (ecosystem) functions of microbial species (or a plant species list with a higher-level specific function or functional category of microbial species) in the assessment result of the state of the ecosystem for each of the plurality of plant species lists.

Here, the higher-level function of microbial species refers to, for example, the indicator value of the function (or functional category) of microbial species being greater than or equal to a threshold.

In a case where it is determined in step S34 that there is no plant species list with one or more higher-level functions of microbial species in the assessment result of the state of the ecosystem for each of the plurality of plant species lists, the processing returns to step S31.

In this case, in step S31, the plant species acquisition unit 51 generates a new plurality of plant species lists on the basis of, for example, the current plurality of plant species lists, and subsequently, similar processing is repeated.

For example, the plant species acquisition unit 51 can generate the new plurality of plant species lists by adding plant species to each of the current plurality of plant species lists, or deleting or changing some plant species in each of the current plurality of plant species lists.

On the other hand, in a case where it is determined in step S34 that there is a plant species list with one or more higher-level functions of microbial species in the assessment result of the state of the ecosystem for each of the plurality of plant species lists, the ecosystem assessment unit 53 provides the assessment result of the state of the ecosystem for the plant species list to the generation unit 54 together with the plant species list with one or more higher-level functions of the microbial species, and the processing proceeds to step S35.

In step S35, the generation unit 54 generates a vegetation strategy to be proposed on the basis of the assessment result of the state of the ecosystem received from the ecosystem assessment unit 53, and the processing proceeds to step S36.

For example, in the assessment result of the state of the ecosystem, the generation unit 54 selects (the plant species of) the plant species list with one or more higher-level functions of the microbial species as the vegetation strategy to be proposed. In a case where there is a plurality of plant species lists with one or more higher-level functions of microbial species, each of the plurality of plant species lists is selected as a different vegetation strategy.

In step S36, the generation unit 54 generates an image as a presentation UI that presents the vegetation strategy, the higher-level function of the microbial species in the ecosystem where the plant species of the vegetation strategy are planted, and the indicator value of the function. The generation unit 54 proposes the vegetation strategy by transmitting the presentation UI to the terminal 11 for display, and the processing is brought to an end.

On the terminal 11, the presentation UI received from the generation unit 54 (server 12) is displayed to propose the vegetation strategy. The user of the terminal 11 can check the vegetation strategy presented by the presentation UI, and the higher-level function of the microbial species in the ecosystem where the plant species of the vegetation strategy are planted and the indicator value of the function, select the vegetation strategy with a higher indicator value of the function of the microbial species aligned with the construction purpose, and take a required action.

For example, the user can select a vegetation strategy with higher-level (indicator value as) diversity of human gut microbiota, a higher indicator value of human health effects, a higher indicator value of carbon fixation function, and the like according to the construction purpose.

Then, the user can know plant species to be newly introduced, plant species to be protected in existing vegetation, and the like from the selected vegetation strategy, and can specify a specific action to be taken, such as introduction of new plant species or replacement of existing plant species, to construct the ecosystem aligned with the construction purpose.

Thereafter, the user can take a specific action to construct the ecosystem aligned with the construction purpose such as improvement of ecosystem functions.

The proposal of the vegetation strategy as described above can be used, for example, in public policy for a sustainable society, consultation business, and the like.

Note that, in a case where the plant species list including the plant species introduced into the ecosystem (hereinafter, also referred to as introduced list) is included in the plant species list transmitted from the terminal 11, the server 12 can include the assessment result of the current state of the ecosystem where the plant species of the introduced list are introduced, in addition to the vegetation strategy and the like, in the presentation UI.

In this case, the user who has checked the presentation UI can perform current state analysis (analysis of the current state of the ecosystem), analysis of how the state of the ecosystem changes in a case where the vegetation strategy is implemented, and the like.

Furthermore, in a case where the introduced list is included in the plant species lists transmitted from the terminal 11, and there is one or more plant species lists with a higher indicator value of the microbial function, the microbial function having a lower indicator value in the assessment result of the state of the ecosystem for the plant species in the introduced list, among the plurality of plant species lists, the server 12 can select the plant species list as the vegetation strategy.

In this case, it is possible to propose a vegetation strategy suitable for the current ecosystem, that is, a vegetation strategy that further enriches the ecosystem functions of the current ecosystem.

### <Assessment of State of Ecosystem Using Assessment Method Based on Construction Purpose>

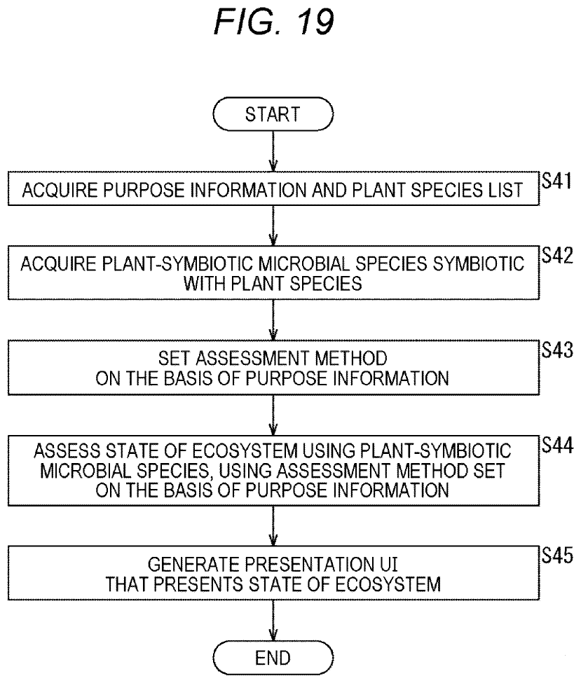

FIG. 19 is a flowchart for describing an example of processing of the server 12 in a case where the assessment method for assessing the state of the ecosystem is set on the basis of the construction purpose and the state of the ecosystem is assessed using the assessment method.

As described with reference to FIG. 1, the user can input, by operating the terminal 11, plant species to be introduced to construct the ecosystem and introduced plant species, and further input the construction purpose for constructing the ecosystem.

In a case where the construction purpose is input, the terminal 11 transmits purpose information indicating the construction purpose to the server 12 together with the plant species list.

In this case, in the server 12, the plant species acquisition unit 51 receives and acquires the plant species list transmitted from the terminal 11, and provides the plant species list to the plant-symbiotic microbial species acquisition unit 52, the ecosystem assessment unit 53, and the generation unit 54 in step S41.

Moreover, in step S41, (the assessment unit 61 of) the ecosystem assessment unit 53 receives and acquires the purpose information transmitted from the terminal 11, and the processing proceeds to step S42.

In step S42, the plant-symbiotic microbial species acquisition unit 52 consults the plant-symbiotic microbial species DB to acquire plant-symbiotic microbial species symbiotic with the plant species in the plant species list received from the plant species acquisition unit 51. The plant-symbiotic microbial species acquisition unit 52 generates a microbial species list including the plant-symbiotic microbial species, and provides the microbial species list to the ecosystem assessment unit 53 and the generation unit 54, and the processing proceeds from step S42 to step S43.

In step S43, the ecosystem assessment unit 53 sets an assessment method for assessing the state of the ecosystem on the basis of (the construction purpose indicated by) the purpose information, and the processing proceeds to step S44.

For example, in a case where the construction purpose indicated by the purpose information is to construct an ecosystem that facilitates the growth of a specific strain such as yeast or koji as a specific microbial species for brewing, fermentation processing, or the like, it is possible to set, as the assessment method, the calculation of microbial diversity of strain-symbiotic microbial species having symbiotic interactions with the specific strain among the plant-symbiotic microbial species as the indicator value of the state of the ecosystem.

Furthermore, for example, in a case where a weighted sum of the indicator values of the functions of the plant-symbiotic microbial species (including the functions of the plant-symbiotic microbial species based on interactions between the plant-symbiotic microbial species and the other biological species) is calculated as the indicator value of the state of the ecosystem, a weight used (in the calculation formula) for calculating the weighted sum can be set as the assessment method on the basis of the purpose information.

For example, in a case where the construction purpose indicated by the purpose information is to promote human health, the weights of the functions belonging to the functional category of human health effects among the functions of the plant-symbiotic microbial species can be set to a large value (for example, 1), and the weights of the other functions can be set to a small value (for example, 0).

In step S44, the ecosystem assessment unit 53 assesses the state of the target ecosystem using the plant-symbiotic microbial species in the microbial species list received from the plant-symbiotic microbial species acquisition unit 52, using the assessment method set on the basis of the purpose information. For example, the ecosystem assessment unit 53 calculates the indicator values of the functions of the plant-symbiotic microbial species in the microbial species list, and calculates a weighted sum of the indicator values as the indicator value of the state of the ecosystem using the weights set on the basis of the purpose information.

The ecosystem assessment unit 53 provides, to the generation unit 54, the indicator value of the state of the ecosystem as the assessment result of the state of the target ecosystem, and the processing proceeds from step S44 to step S45.

In step S45, the generation unit 54 generates an image as a presentation UI that presents the indicator value of the state of the ecosystem received from the ecosystem assessment unit 53, and transmits the image to the terminal 11, and the processing is brought to an end.

As described above, by setting the assessment method on the basis of the construction purpose indicated by the purpose information, for example, in a case where the microbial diversity of the microbial species having symbiotic interactions with a specific microbial species such as yeast among the plant-symbiotic microbial species is calculated as the indicator value of the state of the ecosystem, the robustness of the ecosystem network is visualized by the presentation UI.

The robustness of the ecosystem network refers to resilience against various disruptive factors of the ecosystem, such as changes in temperature or the emergence of specific viruses.

Higher biodiversity suppresses an explosive increase of a certain type of virus or a specific biological species such as microorganisms or insects. Therefore, it can be said that biodiversity represents the robustness of the ecosystem network.

In a case where the microbial diversity of microbial species having symbiotic interactions with a specific microbial species among the plant-symbiotic microbial species is calculated as the indicator value of the state of the ecosystem and is presented by the presentation UI, it can be said that the robustness of the ecosystem network represented by the microbial diversity corresponding to the indicator value is visualized.

The user checks the robustness of the ecosystem network visualized by the presentation UI, and in a case where the robustness is low, the user can reduce the risk of damage caused by an explosive increase of a specific harmful species by taking an action such as the introduction of a plant species that improves biodiversity or the introduction of a plant species that attracts (is symbiotic with) microbial species.

Furthermore, in setting the assessment method on the basis of the construction purpose indicated by the purpose information, for example, in a case where the weight of the weighted sum is set, it is possible to calculate an indicator value aligned with the construction purpose (appropriate indicator value as a measure of the ecosystem aligned with the construction purpose) from indicator values of various variations of the state of the ecosystem.

Note that setting the assessment method for assessing the state of the ecosystem on the basis of (the construction purpose indicated by) the purpose information and assessing the state of the ecosystem using the assessment method can also be applied to a case where the vegetation strategy described with reference to FIG. 18 is proposed.

In this case, in step S33 in FIG. 18, the ecosystem assessment unit 53 calculates, as the indicator value of the state of the ecosystem, the weighted sum of the indicator values of the functions of the plant-symbiotic microbial species in the microbial species list using the weight set on the basis of the purpose information, for example.

Then, in step S34, it is determined whether or not there is a plant species list with a higher indicator value of the state of the ecosystem (greater than or equal to the threshold), and in step S35, the plant species list with a higher indicator value of state of the ecosystem is selected as the vegetation strategy.

In this case, it is possible to propose a vegetation strategy that constructs an ecosystem aligned with the construction purpose, such as an ecosystem with higher-level diversity of gut microbiota or an ecosystem that facilitates the growth of a specific species.

Moreover, for example, each organization, such as a construction company involved in urban planning, a hospital or nursing home considering vegetation planning, or a manufacturer considering vegetation planning for former factory sites or aiming to increase the amount of carbon fixation, can accumulate vegetation strategies suitable for the organization's purpose by receiving proposals of vegetation strategies, with the organization's purpose set as the construction purpose.

### <Another Example of Plant-Symbiotic Microbial Species DB>

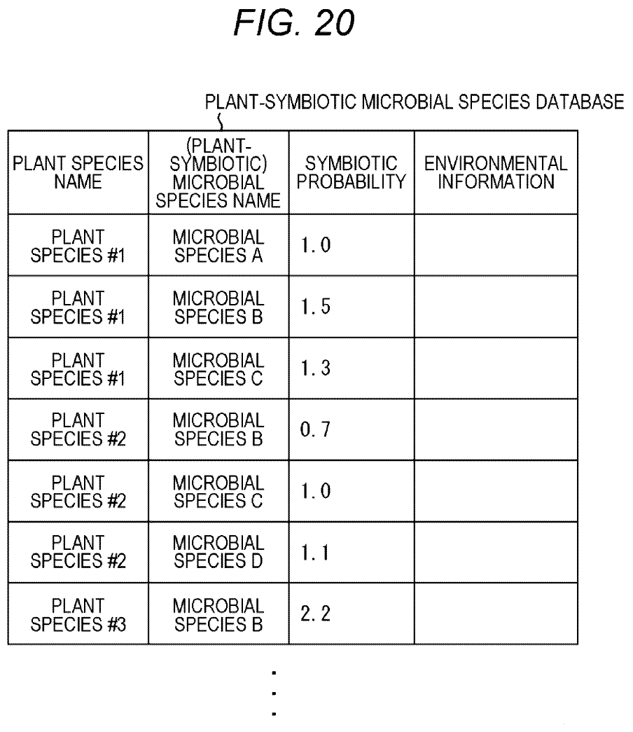

FIG. 20 is a diagram illustrating another example of the plant-symbiotic microbial species DB of the database 13.

In FIG. 20, the plant-symbiotic microbial species DB stores various plant species, plant-symbiotic microbial species symbiotic with the plant species, symbiotic probability, and environmental information in association with each other.

Therefore, the plant-symbiotic microbial species DB in FIG. 20 is the same as the case in FIG. 7 in that the plant species, the plant-symbiotic microbial species, and the symbiotic probability are stored.

Note that the plant-symbiotic microbial species DB in FIG. 20 is different from the case in FIG. 7 in that the environmental information is stored.

The environmental information is information indicating an environment of a region (location) where symbiosis between plant species and plant-symbiotic microbial species associated with the plant species is confirmed (observed), such as climate (including tropical rainforest climate, a climate zone such as a tropical climate zone or a dry climate zone, and a climatic region), (average) temperature, (average) humidity, and (average) precipitation.

In a case where the plant-symbiotic microbial species DB in FIG. 20 is used, the terminal 11 transmits not only the plant species list but also the environmental information of the target ecosystem to the server 12.

The environmental information of the target ecosystem can be input by the user operating the terminal 11, for example.

In a case where the user is in a certain location, and the plant species in the location are input into the terminal 11, the terminal 11 can transmit information indicating the temperature, humidity, and the like of the location detected by the sensor unit 26 to the server 12 as the environmental information of the target ecosystem. Furthermore, the terminal 11 can identify the climate of the location indicated by location information of the terminal 11 obtained by the positioning unit 25 and include the climate in the environmental information of the target ecosystem.

In the server 12, the plant-symbiotic microbial species acquisition unit 52 receives the environmental information of the target ecosystem transmitted from the terminal 11.

The plant-symbiotic microbial species acquisition unit 52 detects (acquires) the plant-symbiotic microbial species associated with the plant species in the plant species list from the plant-symbiotic microbial species associated with environmental information corresponding to the environment indicated by the environmental information of the target ecosystem, that is, the plant-symbiotic microbial species associated with environmental information indicating an environment similar to the environment indicated by the environmental information of the target ecosystem in the plant-symbiotic microbial species DB.

Here, the microbial species symbiotic with a certain plant species may vary in a manner that depends on the environment.

Therefore, the plant-symbiotic microbial species acquisition unit 52 detects the plant-symbiotic microbial species associated with the plant species in the plant species list from among the plant-symbiotic microbial species associated with the environmental information corresponding to the environment indicated by the environmental information of the target ecosystem in the plant-symbiotic microbial species DB. It is therefore possible to detect plant-symbiotic microbial species that are highly likely to be symbiotic with the plant species in the plant species list in the target ecosystem.

Then, by assessing the state of the target ecosystem and proposing (generating) a vegetation strategy based on the assessment result using such plant-symbiotic microbial species, it is possible to increase the accuracy of the assessment of the state of the target ecosystem (the assessment performed by the ecosystem assessment unit 53) and the accuracy of the vegetation strategy.

As described above, by storing the environmental information indicating the environment of the region where the symbiosis of the plant-symbiotic microbial species associated with the plant species has been confirmed in the plant-symbiotic microbial species DB in association with the plant species, it is possible to assess the state of the target ecosystem and propose the vegetation strategy using the plant-symbiotic microbial species confirmed to be symbiotic with the plant species in an environment similar to the environment such as the climate of the target ecosystem, and to increase the accuracy of the assessment result of the state of the target ecosystem and the accuracy of the vegetation strategy.

Note that, in a case where the user confirms (observes) symbiosis between the plant species and the microbial species, the user can transmit (the information regarding) the plant species and the microbial species and the environmental information indicating the environment of the location where the symbiosis has been confirmed to the plant-symbiotic microbial species DB for storage from the terminal 11 or the like. As described above, as the storage of the environmental information in the plant-symbiotic microbial species DB progresses, a plant-symbiotic microbial species DB tailored to various environments is constructed, allowing a further increase in the accuracy of the assessment result of the state of the target ecosystem and the accuracy of the vegetation strategy.

### <Presentation UI>

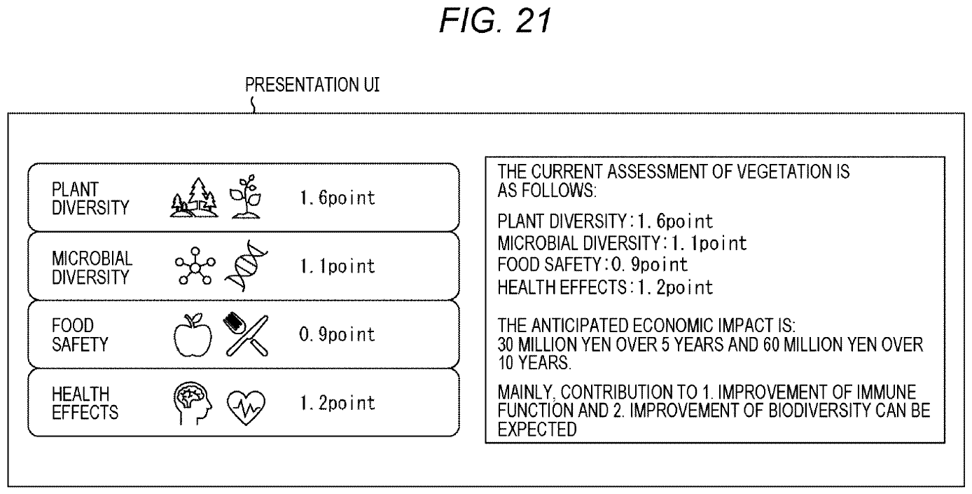

FIG. 21 is a diagram illustrating a first example of the presentation UI.

The presentation UI in FIG. 21 presents (displays), as the indicator value (assessment result) of the state of the (target) ecosystem, the plant diversity of 1.6 points, the microbial diversity of 1.1 points, the indicator value of food safety of 0.9 points, and the indicator value of health effects of 1.2 points. Note that the presentation UI can present indicator values not illustrated in FIG. 21, such as diversity of gut microbiota.

The points (indicator values) of plant diversity and microbial diversity are, for example, values corresponding to the numbers of species of plant species and microbial species.

The indicator value of food safety is, for example, a weighted sum (sum total) of the indicator values of the functions (of the microbial species) contributing to prevention of diseases such as improvement of immune function for livestock such as pigs, vegetables such as cucumbers, and other edible species.

The indicator value of health effects is a weighted sum of the indicator values of the functions belonging to the functional category of human health effects.

The presentation UI in FIG. 21 further presents a message “The anticipated economic impact is 30 million yen over 5 years and 60 million yen over 10 years.” indicating the environmental economic value of the ecosystem functions of the ecosystem as the indicator value of the state of the ecosystem.

The environmental economic value of the ecosystem functions of the ecosystem can be calculated, for example, as described with reference to FIG. 17.

In addition, the presentation UI in FIG. 21 presents a message “Mainly, contribution to 1. improvement of immune function and 2. improvement of biodiversity can be expected” indicating expected effects on the (target) ecosystem where the plant species in the plant species list are planted.

In the generation unit 54, an indicator value greater than or equal to the threshold is detected from the indicator value of the function or functional category calculated in the assessment of the state of the ecosystem, and the message indicating the expected effects on the ecosystem is generated using the function or functional category corresponding to the indicator value.

In FIG. 21, since the indicator value of the function of improving immune function for humans and the indicator value of the function of improving biodiversity are greater than or equal to the threshold, the message “Mainly, contribution to 1. improvement of immune function and 2. improvement of biodiversity can be expected” indicating expected effects on the ecosystem is generated using the function of improving immune function and the function of improving biodiversity.

Note that, in FIG. 21, as the indicator value of the state of the ecosystem, the indicator value of plant diversity, the indicator value of microbial diversity, the indicator value of food safety, and the indicator value of health effects are presented; however, as the indicator value of the state of the ecosystem, for example, indicator values of various functions or functional categories such as the indicator value of carbon fixation function or a weighted sum of the indicator values can be presented.

The presentation UI as described above visualizes the indicator value of the state of the ecosystem where the plant species in the plant species list are planted and the expected effects on the ecosystem, allowing the user to easily recognize the indicator value of the state of the ecosystem and the expected effects on the ecosystem. For example, in a case where the ecosystem where the plant species in the plant species list are planted is constructed, it is possible to easily recognize the environmental economic value (long-term economic benefits) of the ecosystem and the like, and the benefits (effects) of the ecosystem functions.

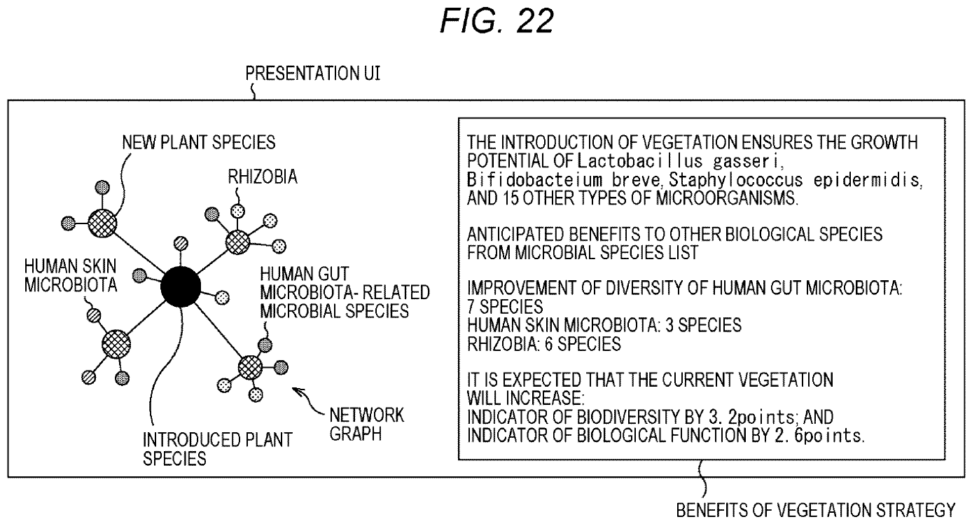

FIG. 22 is a diagram illustrating a second example of the presentation UI.

FIG. 22 illustrates an example of the presentation UI that presents, in a case where the vegetation strategy is proposed as described with reference to FIG. 18, vegetation strategy-related information related to the vegetation strategy such as benefits of the vegetation strategy presented together with the vegetation strategy.

For example, for the proposal of the vegetation strategy, a plurality of plant species lists is generated on the basis of one plant species list received from the terminal 11, such as a plant species list including plant species already introduced into the ecosystem, and in a case where the vegetation strategy is selected from the plurality of plant species lists, the generation unit 54 can generate vegetation strategy-related information including, for example, the benefits of the vegetation strategy based on the state where the plant species (introduced plant species) in the plant species list (hereinafter, also referred to as base list), which is the base of the generation of the plurality of plant species lists, are planted, and generate a presentation UI that presents the vegetation strategy-related information.

The presentation UI in FIG. 22 presents a network graph of plant species as the vegetation strategy and plant-symbiotic microbial species symbiotic with the plant species, and benefits of the vegetation strategy as vegetation strategy-related information.

In the network graph in FIG. 22, nodes represented by large circles indicate the plant species as the vegetation strategy, and nodes represented by small circles indicate the plant-symbiotic microbial species.

Links represented by lines connecting the plant species and the plant-symbiotic microbial species indicate symbiotic relationships between the plant species and the plant-symbiotic microbial species. Links represented by lines connecting the plant species indicate interactions between the plant species.

In a case where the plant species as the vegetation strategy include the introduced plant species in the base list and new plant species different from the introduced plant species in the base list, (the nodes indicating) the introduced plant species and the new plant species are presented in a distinguishable manner in the network graph.

The network graph in FIG. 22 includes human gut microbiota-related microorganisms, human skin microbiota, and rhizobia as the plant-symbiotic microbial species, and the human gut microbiota-related microbial species, the human skin microbiota, and the rhizobia are presented in a distinguishable manner.

The network graph is generated on the basis of the plant species in the plant species list as the vegetation strategy, the microbial species in the microbial species list, the plant-symbiotic microbial species DB, and the like.

As the benefits of the vegetation strategy, a message regarding microbial species that thrive in a case where the vegetation strategy is implemented: “The introduction of vegetation ensures the growth potential of Lactobacillus Gasseri, Bifidobacteium breve, Staphylococcus epidermidis, and 15 other types of microorganisms.”, seven species for the improvement of diversity of human gut microbiota, three species for the human skin microbiota, and six species for the rhizobia are presented.

Moreover, as the benefits of the vegetation strategy, it is presented that the biodiversity is expected to increase by 3.2 points and the ecosystem function is expected to increase by 2.6 points in a case where the vegetation strategy is implemented.

The points by which the biodiversity and the ecosystem function increase are calculated on the basis of the assessment result of the state of the ecosystem for each of the base list and the plant species list as the vegetation strategy.

For example, the point by which the biodiversity increases is calculated using a weighted sum (sum total) of the indicator values of the functions related to biodiversity such as improvement of biodiversity and improvement of insect diversity.

Furthermore, for example, the point by which the ecosystem function increases is calculated using a weighted sum of the indicator values of the functions of the plant-symbiotic microbial species in the microbial species list.

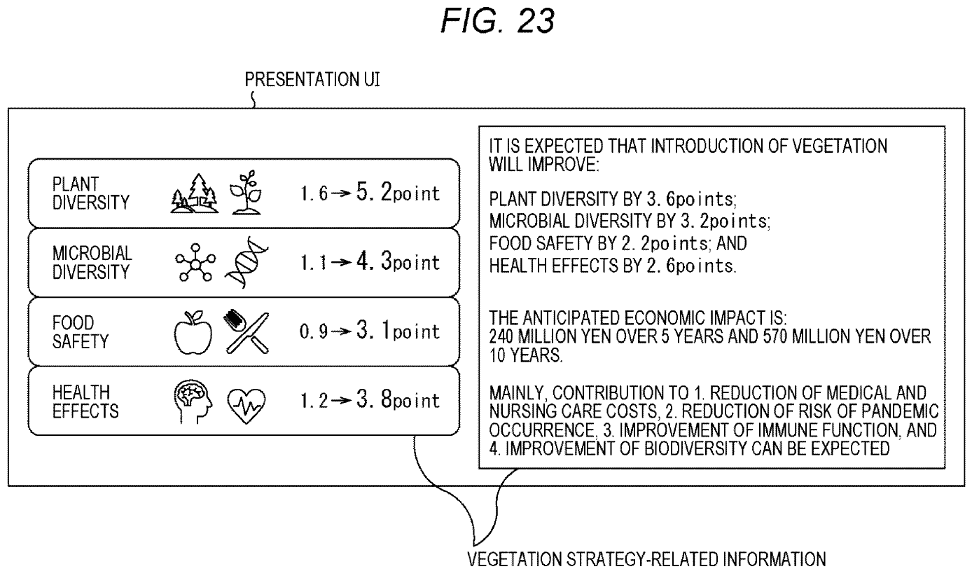

FIG. 23 is a diagram illustrating a third example of the presentation UI.

FIG. 23 illustrates another example of the presentation UI that presents, in a case where the vegetation strategy is proposed as described with reference to FIG. 18, vegetation strategy-related information presented together with the vegetation strategy.

The presentation UI in FIG. 23 presents, in a manner similar to the case in FIG. 22, vegetation-related information in a case where the vegetation strategy is proposed.

The presentation UI in FIG. 23 presents, in a case where the vegetation strategy based on the state where the introduced plant species are planted is implemented, an improvement of plant diversity from 1.6 points to 5.2, that is, by 3.6 points, an improvement of microbial diversity from 1.1 points to 4.3 points, that is, by 3.2 points, an improvement of food safety from 0.9 points to 3.1 points, that is, by 2.2 points, and an improvement of health effects from 1.2 points to 3.8 points, that is, by 2.6 points, as the vegetation strategy-related information.

Moreover, the presentation UI in FIG. 23 presents, in a case where the vegetation strategy is implemented, a message “The anticipated economic impact is 240 million yen over 5 years and 570 million yen over 10 years.” indicating an improvement of the environmental economic value of the ecosystem functions of the ecosystem as the vegetation strategy-related information.

In addition, the presentation UI in FIG. 21 presents a message “Mainly, contribution to 1. reduction of medical and nursing care costs, 2. reduction of the risk of pandemic occurrence, 3. improvement of immune function, and 4. improvement of biodiversity can be expected.” indicating significant improvement effects in a case where the vegetation strategy is implemented.

The generation unit 54 generates the message indicating significant improvement effects in a case where the vegetation strategy is implemented using the function or the functional category having an improvement amount (increase amount in the point as the indicator value) in the indicator value of the function or the functional category calculated during the assessment of the state of the ecosystem is greater than or equal to the threshold.

In FIG. 23, since the improvement amount of the indicator value of the function of improving immune function for humans and the improvement amount of the indicator value of the function of improving biodiversity are greater than or equal to the threshold, in the message indicating significant improvement effects in a case where the vegetation strategy is implemented, a message indicating that the contribution to the improvement of immune function and the contribution to the improvement of biodiversity are expected is displayed.

Note that, in FIG. 23, in the message indicating significant improvements effects in a case where the vegetation strategy is implemented, a message indicating that the contribution to the reduction of medical and nursing care costs and the contribution to the reduction of the risk of pandemic occurrence are expected is displayed. The contribution to the reduction of medical and nursing care costs and the contribution to the reduction of the risk of pandemic occurrence can be displayed, for example, in a case where the improvement amount of the indicator value of the functional category of human health effects is greater than or equal to the threshold.

As described above, by presenting the vegetation strategy-related information in the presentation UI, the user can easily grasp the impacts on biodiversity, such as plant diversity and microbial diversity, in a case where the vegetation strategy based on the state where the plant species in the base list are planted is implemented.

For example, the user can numerically grasp the improvement amount, achieved by the vegetation strategy, of effects produced by improvement of biodiversity and various functions such as carbon fixation that are not illustrated in FIG. 23. Furthermore, the user can quantitatively assess the vegetation strategy on the basis of the numerical value, and use the result for selection of the vegetation strategy to be implemented, planning of the vegetation strategy, and the like.

### <Another Example of Outline of Processing of Server 12>

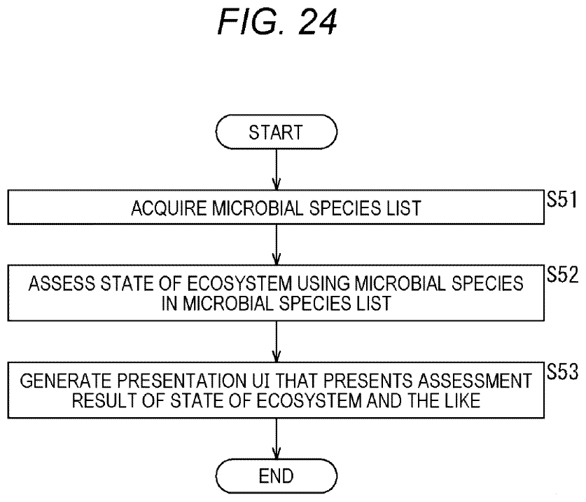

FIG. 24 is a flowchart for describing another example of the outline of the processing of the server 12.

In the above-described case, the server 12 acquires the plant-symbiotic microbial species symbiotic with the plant species in the plant species list as the microbial species that can thrive in the target ecosystem, and assesses the state of the target ecosystem using the plant-symbiotic microbial species; however, in a case where the target ecosystem is a real-world ecosystem (existing ecosystem), it is possible to assess, using (the information regarding) microbial species acquired through analysis of samples collected from the real-world target ecosystem, the state of the target ecosystem, that is, the ecosystem where the samples are collected.

The flowchart in FIG. 24 illustrates an outline of processing of the server 12 in a case where the state of the target ecosystem is assessed using the microbial species acquired through analysis of samples collected from the real-world target ecosystem.

In this case, the user can collect samples from the real-world target ecosystem, send the samples to an analysis company for metagenomic analysis or the like, and request the analysis company to transmit, to the terminal 11, a microbial species list including microbial species identified (obtained) from environmental DNA through the metagenomic analysis or the like.

The microbial species in the microbial species list received from the analysis company correspond to microbial species existing in the real-world target ecosystem.

In this case, the terminal 11 transmits the microbial species list received from the analysis company to the server 12. Note that, in a case where the server 12 calculates plant diversity as the indicator value of the state of the target ecosystem, the terminal 11 further transmits a plant species list including plant species existing in the target ecosystem together with the microbial species list.

In step S51, the plant-symbiotic microbial species acquisition unit 52 receives and acquires the microbial species list transmitted from the terminal 11, and provides the microbial species list to the ecosystem assessment unit 53 and the generation unit 54, and the processing proceeds to step S52.

In step S52, the ecosystem assessment unit 53 assesses the state of the target ecosystem using the microbial species in the microbial species list received from the plant-symbiotic microbial species acquisition unit 52, in a manner similar to step S13 in FIG. 5.

The ecosystem assessment unit 53 provides, to the generation unit 54, the indicator value of the state of the target ecosystem as the assessment result of the state of the target ecosystem, and the processing proceeds from step S52 to step S53.

In step S53, the generation unit 54 generates an image as a presentation UI that presents the assessment result of the state of the target ecosystem and the like received from the ecosystem assessment unit 53, and transmits the image to the terminal 11, in a manner similar to step S14 in FIG. 5, and the processing is brought to an end.

As described above, assessing the state of the target ecosystem using the microbial species acquired through analysis of the samples collected from the real-world target ecosystem requires analysis costs, but allows highly accurate assessment.

### <Assessment of State of Ecosystem Using Assessment Method Aimed at Reducing Risk of Pandemic Infections in Livestock Animals>

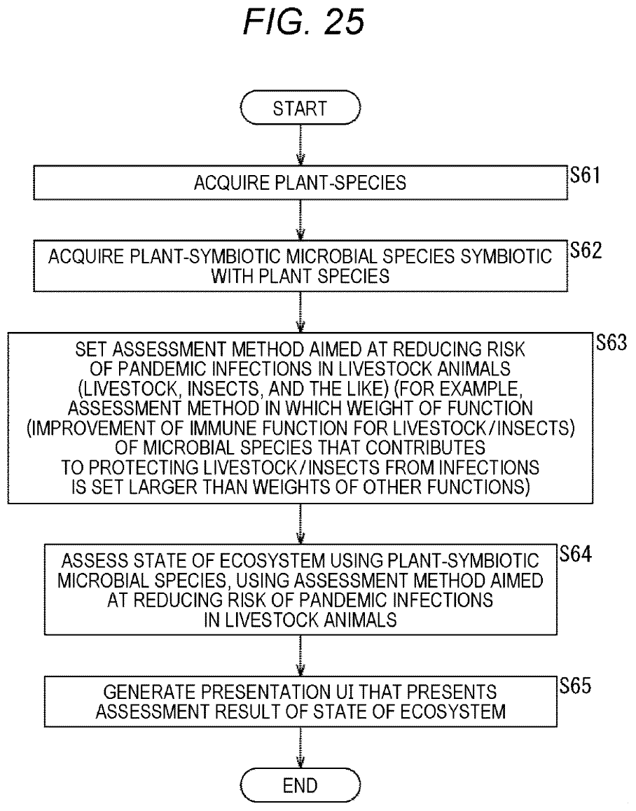

FIG. 25 is a flowchart for describing an example of processing of the server 12 in a case where the state of the ecosystem is assessed using an assessment method aimed at reducing the risk of pandemic infections in livestock animals.

Examples of the livestock animals include species used in animal husbandry such as pigs, cattle, chickens, and insects such as honeybees in apiculture.

A decline in the health of the ecosystem such as a soil (topsoil) ecosystem (the robustness of the ecosystem network) causes overgrowth of a single virus or bacterium, and causes pandemic infections in livestock animals.

In order to reduce the risk of pandemic infections in livestock animals, for example, it is necessary to improve the health of the ecosystem.

Microbial diversity is one of the indicators of the health of the ecosystem. It is therefore possible to assess the health of the ecosystem using the microbial diversity as an indicator, and in a case where the health of the ecosystem is low, it is possible to reduce the risk of pandemic infections in livestock animals by taking a measure to improve the microbial diversity.

The microbial diversity can be calculated (estimated) through, for example, metagenomic analysis, but metagenomic analysis requires costs.

Therefore, the server 12 assesses the state of the ecosystem using the assessment method aimed at reducing the risk of pandemic infections in livestock animals as the indicator of the health of the ecosystem, so that the state of the ecosystem as the indicator of the health of the ecosystem can be assessed without incurring the costs required for the metagenomic analysis. Moreover, it is possible to propose a vegetation strategy (improvement strategy) for enhancing (improving) the health of the ecosystem on the basis of such an assessment result of the state of the ecosystem.

In a case where the server 12 assesses the state of the ecosystem using the assessment method aimed at reducing the risk of pandemic infections in livestock animals, in step S61, the plant species acquisition unit 51 receives and acquires the plant species list transmitted from the terminal 11 and provides the plant species list to the plant-symbiotic microbial species acquisition unit 52, the ecosystem assessment unit 53, and the generation unit 54, and the processing proceeds to step S62.

In step S62, the plant-symbiotic microbial species acquisition unit 52 consults the plant-symbiotic microbial species DB to acquire plant-symbiotic microbial species symbiotic with the plant species in the plant species list received from the plant species acquisition unit 51. The plant-symbiotic microbial species acquisition unit 52 generates a microbial species list including the plant-symbiotic microbial species, and provides the microbial species list to the ecosystem assessment unit 53 and the generation unit 54, and the processing proceeds from step S62 to step S63.

In step S63, the ecosystem assessment unit 53 sets the assessment method aimed at reducing the risk of pandemic infections in livestock animals as the assessment method for assessing the state of the ecosystem, and the processing proceeds to step S64.

For example, the ecosystem assessment unit 53 sets an assessment method in which the weight of the function of the microbial species that contributes to protecting livestock and/or insects from infections, such as improvement of immune function for livestock and/or insects, is set larger than the weights of the other functions.

In step S64, the ecosystem assessment unit 53 assesses the state of the target ecosystem using the plant-symbiotic microbial species in the microbial species list received from the plant-symbiotic microbial species acquisition unit 52, using the assessment method aimed at reducing the risk of pandemic infections in livestock animals set in step S63.

That is, for example, the ecosystem assessment unit 53 calculates the indicator value of each function of the plant-symbiotic microbial species in the microbial species list. Then, the ecosystem assessment unit 53 calculates, as the indicator value of the state of the ecosystem, a weighted sum of the indicator values of the functions of the plant-symbiotic microbial species in the microbial species list with the weight of the function of the plant-symbiotic microbial species that contributes to protecting livestock animals from infections set to, for example, 1, and the weights of the other functions set to, for example, 0.

The ecosystem assessment unit 53 provides, to the generation unit 54, the indicator value of the state of the ecosystem as the assessment result of the state of the target ecosystem, and the processing proceeds from step S64 to step S65.

In step S65, the generation unit 54 generates an image as a presentation UI that presents the indicator value of the state of the ecosystem received from the ecosystem assessment unit 53, and transmits the image to the terminal 11, and the processing is brought to an end.

As described above, it is possible to assess the health of the ecosystem by assessing the state of the ecosystem using the assessment method aimed at reducing the risk of pandemic infections in livestock animals as the indicator of the health of the ecosystem.

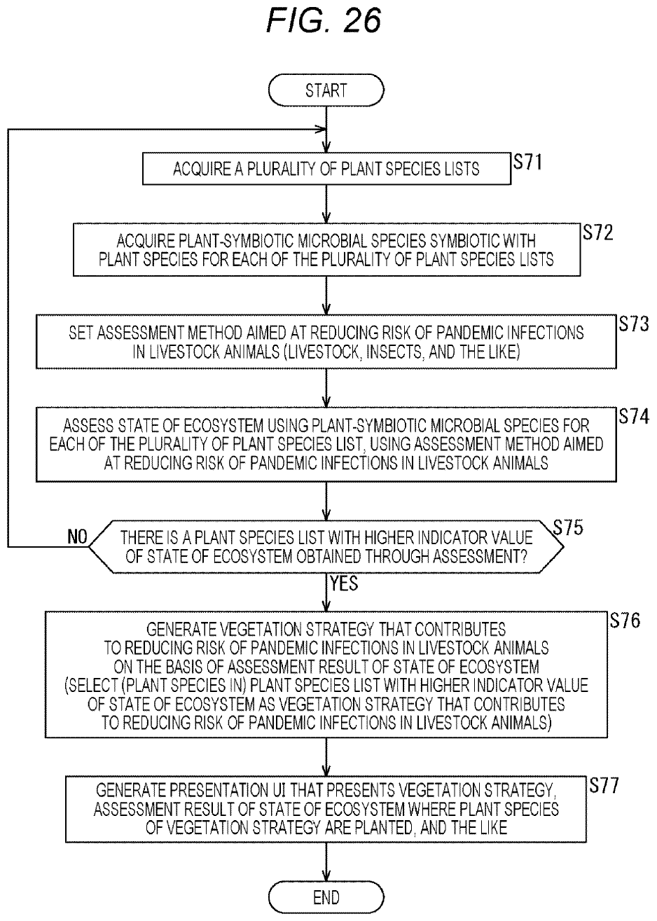

FIG. 26 is a flowchart for describing an example of processing of the server 12 in a case where a vegetation strategy aimed at reducing the risk of pandemic infections in livestock animals is proposed.

In step S71, the plant species acquisition unit 51 acquires a plurality of plant species lists based on a single plant species list received from the terminal 11, and provides the plurality of plant species lists to the plant-symbiotic microbial species acquisition unit 52, the ecosystem assessment unit 53, and the generation unit 54 in a manner similar to step S31 in FIG. 18, and the processing proceeds to step S72.

In step S72, the plant-symbiotic microbial species acquisition unit 52 consults the plant-symbiotic microbial species DB to acquire plant-symbiotic microbial species symbiotic with the plant species in each of the plurality of plant species lists received from the plant species acquisition unit 51. The plant-symbiotic microbial species acquisition unit 52 generates a microbial species list including the plant-symbiotic microbial species for each of the plurality of plant species lists, and provides the microbial species list to the ecosystem assessment unit 53 and the generation unit 54, and the processing proceeds from step S72 to step S73.

In step S73, the ecosystem assessment unit 53 sets the assessment method aimed at reducing the risk of pandemic infections in livestock animals as the assessment method for assessing the state of the ecosystem in a manner similar to step S63 in FIG. 25, and the processing proceeds to step S74.

In step S74, (the assessment unit 61 of) the ecosystem assessment unit 53 assesses the state of the ecosystem using the plant-symbiotic microbial species in the microbial species list received from the plant-symbiotic microbial species acquisition unit 52 for each of the plurality of plant species list, using the assessment method aimed at reducing the risk of pandemic infections in livestock animals set in step S63, in a manner similar to step S64 in FIG. 25, and the processing proceeds to step S75.

In step S75, the ecosystem assessment unit 53 determines whether or not there is a plant species list with a higher indicator value of the state of the ecosystem obtained through the assessment of the state of the ecosystem for each of the plurality of plant species lists.

Here, the higher indicator value of the state of the ecosystem refers to, for example, the indicator value of the state of the ecosystem being greater than or equal to the threshold.

In a case where it is determined in step S75 that there is no plant species list with a higher indicator value of the state of the ecosystem, the processing returns to step S71.

In this case, in step S71, the plant species acquisition unit 51 generates a new plurality of plant species lists on the basis of the current plurality of plant species lists, and subsequently, similar processing is repeated, in a manner similar to the case described with reference o FIG. 18.

On the other hand, in a case where it is determined in step S75 that there is a plant species list with a higher indicator value of the state of the ecosystem, the ecosystem assessment unit 53 provides, to the generation unit 54, the assessment result (indicator value) of the state of the ecosystem for the plant species list with a higher indicator value of the state of the ecosystem together with the plant species list, and the processing proceeds to step S76.

In step S76, the generation unit 54 generates a vegetation strategy that contributes to reducing the risk of pandemic infections in livestock animals on the basis of the assessment result of the state of the ecosystem received from the ecosystem assessment unit 53, and the processing proceeds to step S77.

For example, the generation unit 54 selects (the plant species in) the plant species list with a higher indicator value of the state of the ecosystem as the vegetation strategy that contributes to reducing the risk of pandemic infections in livestock animals.

In step S77, the generation unit 54 generates an image as a presentation UI that presents the vegetation strategy, the assessment result (indicator value) of the state of the ecosystem where the plant species of the vegetation strategy are planted, and the like. The generation unit 54 proposes the vegetation strategy by transmitting the presentation UI to the terminal 11 for display, and the processing is brought to an end.

As described above, it is possible to propose, using the plant species list received from the terminal 11, a specific action to reduce (avoiding) the risk of pandemic infections in livestock animals, that is, a vegetation strategy.

According to the proposed vegetation strategy, it is possible to expect contributions to food security and sustainability of livestock industry amid climate change and declining ecosystem functions. Note that, for the calculation of the assessment value of the state of the ecosystem in FIGS. 25 and 26, the microbial diversity of the plant-symbiotic microbial species in the microbial species list can be further used.

Herein, the processing to be performed by the computer in accordance with the program need not necessarily be performed in the time-series order described as the flowcharts. In other words, the processing to be performed by the computer in accordance with the program includes processing to be performed in parallel or independently (e.g., parallel processing or object-oriented processing).

Furthermore, the program may correspond to processing to be performed by a single computer (single processor) or processing to be performed in a distributed manner by a plurality of computers. Moreover, the program may be transferred to a distant computer to be executed.

Moreover, herein, a system means a set of a plurality of components (devices, modules (parts), and the like), and it does not matter whether or not all the components are in the same housing. Therefore, a plurality of devices housed in separate housings and connected to each other over a network and a single device including a plurality of modules housed in a single housing are both systems.

Note that the embodiment of the present technology is not limited to the above-described embodiments, and various changes can be made without departing from the gist of the present technology.

For example, the present technology may be embodied in cloud computing in which a function is executed by a plurality of devices via a network in a shared manner.

Furthermore, each step described in the flowcharts described above can be performed by one device or can be performed by a plurality of devices in a shared manner.

Moreover, in a case where a single step includes a plurality of processes, the plurality of processes included in the single step can be performed by a single device or performed by a plurality of devices in a shared manner.

Furthermore, the effects described herein are merely examples and are not restrictive, and there may be other effects.

Note that the present technology can relate to at least Goal 1 “No Poverty”, Goal 2 “Zero Hunger”, Goal 3 “Good Health and Well-being”, Goal 13 “Climate Action”, and Goal 15 “Life on Land” among the sustainable development goals (SDGs) adopted at the UN summit in 2015.

Synecoculture (registered trademark) used in the present technology enables the cultivation of plants by controlling the ecosystem to promote biodiversity and to be resilient to climate changes caused by natural disasters such as droughts and landslides. Furthermore, it is possible to increase a fixed amount of greenhouse gases (GHGs) in order to generate a state where plants are mixed densely, and it is further possible to contribute to reducing greenhouse gas emissions without using fertilizers or pesticides. Furthermore, it is possible to contribute to health care in order to improve not only the biodiversity in the environment but also the diversity of gut microbiota.

Note that the present technology may have the following configurations.

<1>

An information processing device including:
an ecosystem assessment unit that assesses a state of an ecosystem where predetermined plant species exist on the basis of interactions between plant-symbiotic microbial species that are microbial species symbiotic with the predetermined plant species and other biological species.
   <2>

The information processing device according to <1>, in which
the predetermined plant species include plant species in a plant species list transmitted from a terminal.
   <3>

The information processing device according to <2>, further including:
a plant-symbiotic microbial species acquisition unit that acquires the plant-symbiotic microbial species symbiotic with the plant species in the plant species list.
   <4>

The information processing device according to <3>, in which
the plant-symbiotic microbial species acquisition unit consults a database on microbial species symbiotic with plant species to acquire the plant-symbiotic microbial species.
   <5>

The information processing device according to <4>, in which
the database stores microbial species symbiotic with plant species with the microbial species associated with environmental information of a location where the symbiosis is observed, and
the plant-symbiotic microbial species acquisition unit acquires the plant-symbiotic microbial species from the microbial species associated with the environmental information corresponding to an environment of the ecosystem.
   <6>

The information processing device according to any one of <1> to <5>, in which
the ecosystem assessment unit consults a database on functions of microbial species including functions based on interactions between the microbial species and the other biological species and assesses the state of the ecosystem on the basis of the interactions between the plant-symbiotic microbial species and the other biological species.
   <7>

The information processing device according to any one of <1> to <6>, in which
the ecosystem assessment unit calculates an indicator value by quantifying the state of the ecosystem as an assessment result of the state of the ecosystem.
   <8>

The information processing device according to <7>, in which
the ecosystem assessment unit calculates, as the indicator value of the state of the ecosystem, an indicator value by quantifying each function of the plant-symbiotic microbial species, the function being based on the interactions between the plant-symbiotic microbial species and the other biological species.
   <9>

The information processing device according to <7>, in which
the ecosystem assessment unit calculates, as the indicator value of the state of the ecosystem, a value using an indicator value obtained by quantifying each function of the plant-symbiotic microbial species, the function being based on the interactions between the plant-symbiotic microbial species and the other biological species.
   <10>

The information processing device according to <9>, in which
the ecosystem assessment unit calculates, as the indicator value of the state of the ecosystem, a value using all or some of the indicator values of the functions of the plant-symbiotic microbial species.
   <11>

The information processing device according to <10>, in which
the ecosystem assessment unit calculates, as the indicator value of the state of the ecosystem, an indicator value calculated using the indicator values of the functions of the plant-symbiotic microbial species belonging to functional categories of functions of microbial species based on common properties for each of the functional categories.
   <12>

The information processing device according to any one of <1> to <11>, further including:
a vegetation strategy generation unit that generates a vegetation strategy on the basis of an assessment result of the state of the ecosystem.
   <13>

The information processing device according to any one of <1> to <12>, in which
the ecosystem assessment unit sets an assessment method for assessing the state of the ecosystem on the basis of purpose information indicating a purpose of constructing the ecosystem, and assesses the state of the ecosystem using the assessment method.
   <14>

The information processing device according to any one of <1> to <12>, in which
the ecosystem assessment unit assesses the state of the ecosystem using an assessment method aimed at reducing a risk of pandemic infections in livestock animals.
   <15>

The information processing device according to any one of <1> to <14>, further including:
a presentation user interface (UI) generation unit that generates a presentation UI that presents an assessment result of the state of the ecosystem.
   <16>

The information processing device according to <15>, in which
the presentation UI generation unit generates the presentation UI that presents a vegetation strategy based on the assessment result of the state of the ecosystem.
   <17>

The information processing device according to <1>, in which
the ecosystem assessment unit calculates, as the indicator value of the state of the ecosystem, an environmental economic value of functions of the ecosystem using the plant-symbiotic microbial species.
   <18>

The information processing device according to <1>, in which
the ecosystem assessment unit assesses a state of an ecosystem where samples have been collected from a real world on the basis of interactions between microbial species acquired through analysis of the samples and other biological species.
   <19>

An information processing method including:
assessing a state of an ecosystem where predetermined plant species exist on the basis of interactions between plant-symbiotic microbial species that are microbial species symbiotic with the predetermined plant species and other biological species.
   <20>

A program causing a computer to function as:
an ecosystem assessment unit that assesses a state of an ecosystem where predetermined plant species exist on the basis of interactions between plant-symbiotic microbial species that are microbial species symbiotic with the predetermined plant species and other biological species.

### REFERENCE SIGNS LIST

10 Information processing system
11-1 to 11-4 Terminal
12 Server
13 Database
14 Network
21 Communication unit
22 Calculation unit
23 Input/output unit
24 Storage
25 Positioning unit
26 Sensor unit
31 Communication unit
32 Calculation unit
33 Input/output unit
34 Storage
51 Plant species acquisition unit
52 Plant-symbiotic microbial species acquisition unit
53 Ecosystem assessment unit
54 Generation unit
61 Assessment unit
71 Training data acquisition unit
72 Learning unit
73 Model storage unit
74 Assessment data acquisition unit
75 Assessment unit

1. An information processing device comprising:
an ecosystem assessment unit that assesses a state of an ecosystem where predetermined plant species exist on a basis of interactions between plant-symbiotic microbial species that are microbial species symbiotic with the predetermined plant species and other biological species.

2. The information processing device according to claim 1, wherein
the predetermined plant species include plant species in a plant species list transmitted from a terminal.

3. The information processing device according to claim 2, further comprising:
a plant-symbiotic microbial species acquisition unit that acquires the plant-symbiotic microbial species symbiotic with the plant species in the plant species list.

4. The information processing device according to claim 3, wherein
the plant-symbiotic microbial species acquisition unit consults a database on microbial species symbiotic with plant species to acquire the plant-symbiotic microbial species.

5. The information processing device according to claim 4, wherein
the database stores microbial species symbiotic with plant species with the microbial species associated with environmental information of a location where the symbiosis is observed, and
the plant-symbiotic microbial species acquisition unit acquires the plant-symbiotic microbial species from the microbial species associated with the environmental information corresponding to an environment of the ecosystem.

6. The information processing device according to claim 1, wherein
the ecosystem assessment unit consults a database on functions of microbial species including functions based on interactions between the microbial species and the other biological species and assesses the state of the ecosystem on a basis of the interactions between the plant-symbiotic microbial species and the other biological species.

7. The information processing device according to claim 1, wherein
the ecosystem assessment unit calculates an indicator value by quantifying the state of the ecosystem as an assessment result of the state of the ecosystem.

8. The information processing device according to claim 7, wherein
the ecosystem assessment unit calculates, as the indicator value of the state of the ecosystem, an indicator value by quantifying each function of the plant-symbiotic microbial species, the function being based on the interactions between the plant-symbiotic microbial species and the other biological species.

9. The information processing device according to claim 7, wherein
the ecosystem assessment unit calculates, as the indicator value of the state of the ecosystem, a value using an indicator value obtained by quantifying each function of the plant-symbiotic microbial species, the function being based on the interactions between the plant-symbiotic microbial species and the other biological species.

10. The information processing device according to claim 9, wherein
the ecosystem assessment unit calculates, as the indicator value of the state of the ecosystem, a value using all or some of the indicator values of the functions of the plant-symbiotic microbial species.

11. The information processing device according to claim 10, wherein
the ecosystem assessment unit calculates, as the indicator value of the state of the ecosystem, an indicator value calculated using the indicator values of the functions of the plant-symbiotic microbial species belonging to functional categories of functions of microbial species based on common properties for each of the functional categories.

12. The information processing device according to claim 1, further comprising:
a vegetation strategy generation unit that generates a vegetation strategy on a basis of an assessment result of the state of the ecosystem.

13. The information processing device according to claim 1, wherein
the ecosystem assessment unit sets an assessment method for assessing the state of the ecosystem on a basis of purpose information indicating a purpose of constructing the ecosystem, and assesses the state of the ecosystem using the assessment method.

14. The information processing device according to claim 1, wherein
the ecosystem assessment unit assesses the state of the ecosystem using an assessment method aimed at reducing a risk of pandemic infections in livestock animals.

15. The information processing device according to claim 1, further comprising:
a presentation user interface (UI) generation unit that generates a presentation UI that presents an assessment result of the state of the ecosystem.

16. The information processing device according to claim 15, wherein
the presentation UI generation unit generates the presentation UI that presents a vegetation strategy based on the assessment result of the state of the ecosystem.

17. The information processing device according to claim 1, wherein
the ecosystem assessment unit calculates, as the indicator value of the state of the ecosystem, an environmental economic value of functions of the ecosystem using the plant-symbiotic microbial species.

18. The information processing device according to claim 1, wherein
the ecosystem assessment unit assesses a state of an ecosystem where samples have been collected from a real world on a basis of interactions between microbial species acquired through analysis of the samples and other biological species.

19. An information processing method comprising:
assessing a state of an ecosystem where predetermined plant species exist on a basis of interactions between plant-symbiotic microbial species that are microbial species symbiotic with the predetermined plant species and other biological species.

20. A program causing a computer to function as:
an ecosystem assessment unit that assesses a state of an ecosystem where predetermined plant species exist on a basis of interactions between plant-symbiotic microbial species that are microbial species symbiotic with the predetermined plant species and other biological species.
